(19) United States
(12) Patent Application Publication
(10) Pub. No.: US 2017/0168174 A1
(43) Pub. Date: Jun. 15, 2017

(54) METHOD AND SYSTEM FOR GENERATING LOW-FREQUENCY SEISMIC SIGNALS WITH A FLOW-MODULATED SOURCE

(71) Applicant: CGG SERVICES SA, Massy, Cedex (FR)

(72) Inventors: Robert DOWLE, Massy (FR); John SALLAS, Plano, TX (US)

(21) Appl. No.: 15/302,008

(22) PCT Filed: Mar. 27, 2015
(86) PCT No.: PCT/IB2015/000538

§ 371 Date: Oct. 5, 2016

Related U.S. Application Data
(60) Provisional application No. 62/025,153, filed on Jul. 16, 2014.
(60) Provisional application No. 61/977,281, filed on Apr. 9, 2014.

(51) Int. Cl. G01V 1/137; G01V 1/38

(52) U.S. Cl. CPC G01V 1/137; G01V 1/38

(57) ABSTRACT

A low-frequency source element is configured to generate seismic waves in water. The low-frequency source element includes includes a hydraulic reservoir configured to hold a given fluid volume; a compliant chamber configured to hold a given gas volume and to accommodate volume changes of the given fluid volume; a rotational kinetic energy actuator configured to impart rotational kinetic energy to the fluid volume; and a flow modulator device configured to transform part of the rotational kinetic energy of the fluid volume into translational energy to generate an acoustic signal.

### BACKGROUND

Technical Field

Embodiments of the subject matter disclosed herein generally relate to methods and systems and, more particularly, to mechanisms and techniques for extending a low-frequency content of seismic waves generated by a marine seismic source array.

Discussion of the Background

Reflection seismology is a method of geophysical exploration to determine the properties of a portion of the earth's subsurface, information that is especially helpful in the oil and gas industry. Marine reflection seismology is based on the use of a controlled source that sends energy waves into the earth. By measuring the time it takes for the reflections to come back to plural receivers, it is possible to estimate the depth and/or composition of the features causing such reflections. These features may be associated with subterranean hydrocarbon deposits.

For marine applications, a seismic survey system 100, as illustrated in FIG. 1, includes a vessel 102 that tows plural streamers 110 (only one is visible in the figure) and a seismic source 130. Streamer 110 is attached through a lead-in cable (or other cables) 112 to vessel 102, while source array 130 is attached through an umbilical 132 to the vessel. A head float 114, which floats at the water surface 104, is connected through a cable 116 to a head end 110A of streamer 110, while a tail buoy 118 is connected, through a similar cable 116, to a tail end 110B of streamer 110. Head float 114 and tail buoy 118 are used, among other things, to maintain the streamer's depth. Seismic sensors 122 are distributed along the streamer and are configured to record seismic data. Seismic sensors 122 may include a hydrophone, geophone, accelerometer, or a combination thereof.

Positioning devices (birds) 128 are attached along the streamer and controlled by a controller 126 for adjusting a position of the streamer according to a survey plan.

Source array 130 has plural source elements 136, which typically are air guns. The source elements are attached to a float 137 to travel at desired depths below the water surface 104. During operation, vessel 102 follows a predetermined path T while source elements 136 emit seismic waves 140. These waves bounce off the ocean bottom 142 and other layer interfaces below the ocean bottom 142 and propagate as reflected/refracted waves 144 that are recorded by sensors 122. The positions of both the source element 136 and recording sensor 122 are estimated based on GPS systems 124 and recorded together with the seismic data in a storage device 127 onboard the vessel. Controller 126 has access to the seismic data and may be used to achieve quality control or even full processing of this data. Controller 126 may be also connected to the vessel's navigation system and other elements of the seismic survey system, e.g., birds 128.

A source element may be vibratory or impulsive (e.g., an air gun). A vibratory source element is described in U.S. Pat. No. 8,830,794 (herein the 794 patent), and an impulsive source element is described in U.S. Pat. No. 4,472,794, the entire contents of which are incorporated herein by reference.

Presently, the air gun is the most commonly used source for marine seismic acquisition. Neither the air gun nor the existing vibratory source elements are effective in the low-frequency range of the spectrum, mainly from 1 to 10 Hz. However, there is increased interest in acquiring low-frequency seismic data in the marine environment that is useful for imaging prospective hydrocarbon reservoirs. For example, the low-frequency energy range is useful in seismic exploration because it provides better depth penetration of the seismic signal, which is extremely valuable for imaging in complex geological settings, such as sub-salt, basalt or even dense carbonate. The successes of advanced techniques, such as seismic inversion, require energy in the low-frequency range. Current air guns do not produce much useful acoustic energy below about 6 Hz.

Marine vibrators were expected to fix this air gun problem. Some marine vibrators recently introduced employ either flextensional shells or pistons that are in effect stroke-limited at low frequency. For an acoustic monopole (a model used to describe a seismic source element) in a liquid medium, the generated acoustic pressure is directly related to the volumetric acceleration of the liquid (considering that the acoustic source operates in a free-field). Thus, in a free-field, to maintain the same acoustic output at 2 Hz as at 4 Hz, the same shell or piston acceleration for both frequencies is required. This means that for a vibrating shell or piston to achieve the same acoustic output at 2 Hz as at 4 Hz, it requires four times the shell or piston displacement (assuming that for sinusoidal motion the displacement is directly proportional to the acceleration times a constant of proportionality that is the inverse of the frequency expressed in radians/s squared). This requirement is burdensome and makes it impractical for use in emitting adequate low frequency signals using existing vibratory sources.

In most cases, marine seismic source elements are towed at modest depths, so the generated acoustic waves are not the same as in a free-field due to the ghost reflection at the sea/air surface. The sea/air interface has an acoustic reflection coefficient very close to −1. It is well-known that this produces spectral notches and peaks in the down-going output source spectrum. This filtering effect of the surface ghost, in effect, is convolved with the marine source element output. For a monopole source element operating at depth z, where the speed of sound is c, there will be a first notch at zero Hz, a 6 dB spectral peak at c/(4z), a spectral notch at c/(2z) and so on.

FIG. 2 illustrates the filtering effect of the surface reflection on the output of a monopole source element when operated at various depths. The filter effect is represented by curves 201, 203 and 205, which correspond to source element depth operation at 5 m, 25 m and 50 m, respectively. Curves 201, 203 and 205, for a frequency of 5 Hz, have values respectively of −13.6 dB, 0 dB and 4.8 dB. Thus, by operating a low-frequency source element at 25 m depth vs. 5 m depth, an effective gain of 13.6 dB of useful acoustic output is achieved. To help reduce the amount of input power required for low-frequency operation, it is desirable to operate the acoustic source element at a depth as deep as it is practical.

Thus, there is a need for a source element that can generate the low-frequency range of seismic data.

### SUMMARY

According to one embodiment, there is a low-frequency source element for generating seismic waves in water. The low-frequency source element includes a hydraulic reservoir configured to hold a given fluid volume; a compliant chamber configured to hold a given gas volume and to accommodate volume changes of the given fluid volume; a rotational kinetic energy actuator configured to impart rotational kinetic energy to the fluid volume; and a flow modulator device configured to transform part of the rotational kinetic energy of the fluid volume into translational energy to generate an acoustic signal.

According to another embodiment, there is a method for generating low-frequency seismic signals. The method includes a step of deploying a source element in water; a step of towing the source element with a vessel; and a step of generating low-frequency seismic signals by transforming, with a flow modulator device, part of a rotational kinetic energy of a fluid volume hold by a hydraulic reservoir into translational energy.

According to still another embodiment, there is a low-frequency source element for generating seismic waves in water. The low-frequency source element includes a working chamber; a compliant chamber in a same housing as the working chamber; a rotational kinetic energy actuator configured to impart rotational kinetic energy to a fluid volume inside the working chamber; and a flow modulator device configured to transform part of the rotational kinetic energy of the fluid volume into translational energy to generate an acoustic signal. The housing houses the working chamber, the compliant chamber, the rotational kinetic energy actuator and the flow modulator.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a seismic acquisition system;

FIG. 2 illustrates the filtering effect of the surface reflection on the output of a monopole source element when operated at various depths;

FIG. 3 is a schematic diagram of a source element that generates low-frequency seismic waves;

FIG. 4A is a schematic diagram of an active source element that has two open ends;

FIG. 4B is a schematic diagram of an active source element having a motor that produces a substantially constant intake flow;

FIG. 4C is a schematic diagram of an active source element having two motors;

FIGS. 5 and 6 are schematic diagrams of another active source element;

FIG. 7 is a schematic diagram of a passive source element;

FIG. 8 is a schematic diagram of a passive source element that has one end closed and one end equipped with a membrane cover;

FIGS. 9A and 9B are schematic diagrams of a passive source element;

FIGS. 10A and 10B are schematic diagrams of another passive source element;

FIGS. 11A and 11B are schematic diagrams of a passive source element;

FIG. 12 is a block diagram of an active source element;

FIGS. 13A and 13B are block diagrams of passive source elements;

FIG. 14 is a schematic diagram a control system for controlling a source element's actuator;

FIG. 15 is a schematic diagram of a fluidic source element;

FIG. 16 is a flowchart of a method for generating low-frequency seismic signals;

FIG. 17 is a schematic diagram of a transitional zone source element with modulated flow;

FIGS. 18A and 18B shows details of the transitional zone source element;

FIG. 19 is a schematic diagram of a well source element with modulated flow;

FIG. 20 is a schematic diagram of an embodiment of the well source element;

FIG. 21 is a schematic diagram of another embodiment of the well source element;

FIG. 22 is a schematic diagram of yet another embodiment of the well source element;

FIGS. 23A-E illustrate the flow modulator of the well source element;

FIG. 24 shows the well source element being attached to a tractor which propels the source through the well;

FIGS. 25A-B illustrate the compliant compartment and its characteristics;

FIG. 26 is a schematic diagram of an adjustable compliant compartment system;

FIG. 27 is a flowchart of a method for processing seismic data; and

FIG. 28 is a schematic diagram of a control device.

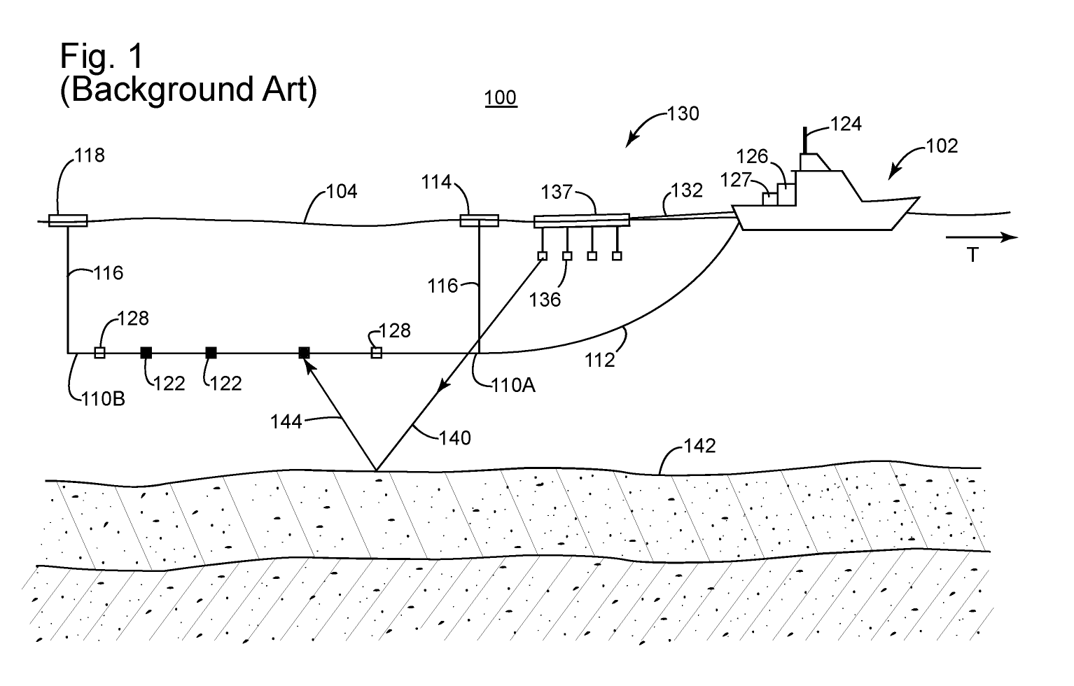

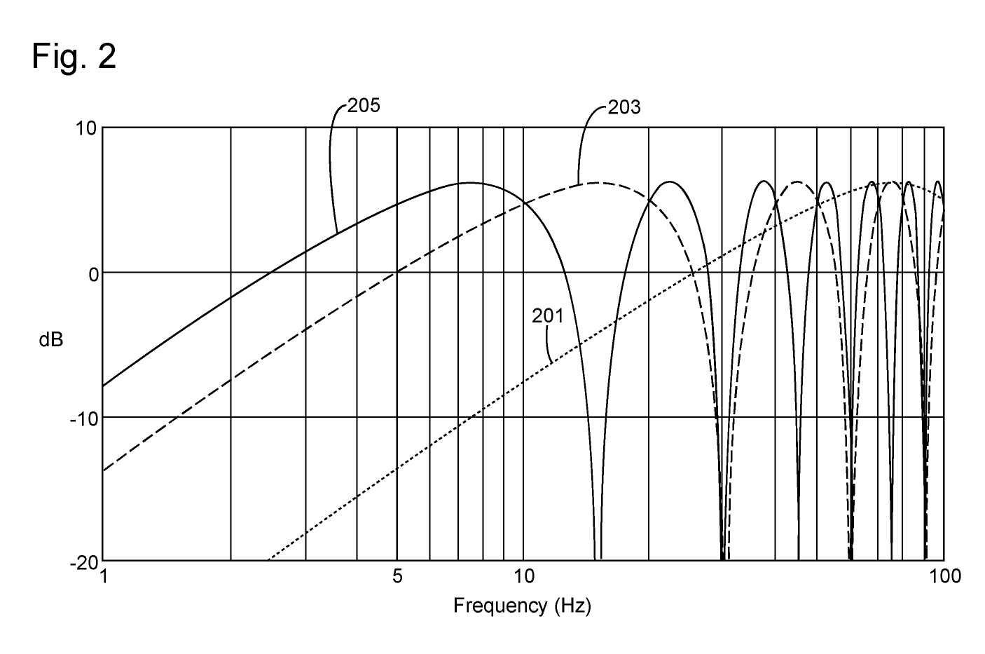

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a source element configured to generate low-frequency acoustic energy in a marine environment. However, the embodiments to be discussed next are not limited to a marine source element; they may be applied to source arrays (i.e., to a collection of source elements) or even to land and transition zone sources.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a source element that generates low frequencies is not constrained by a stroke limitation and can be towed behind a seismic vessel and operated at a given depth. Such a source element includes a hydraulic reservoir configured to receive a given fluid volume, a compliant chamber configured to hold a given gas volume, an actuator configured to impart kinetic energy to the fluid volume, and a flow modulator device configured to modulate the fluid volume's flow to generate an acoustic signal.

According to another embodiment, a source element includes a hydraulic reservoir configured to hold a given fluid volume, a compliant chamber configured to hold a given gas volume, a rotational kinetic energy actuator configured to impart rotational kinetic energy to the fluid volume, and a flow modulator device configured to transform part of the rotational kinetic energy of the fluid volume into translational energy to generate an acoustic signal.

The low range of frequencies is mainly considered to extend from 1 Hz up to about 10 Hz. Above 10 Hz, existing air gun sources provide adequate source strength. Thus, the present embodiments introduce source elements that focus on the low-frequency range. However, these source elements are also capable of generating middle- and high-frequency ranges.

Prior to discussing various embodiments of the novel source elements that generate acoustic energy in the low-frequency range, some nomenclature is introduced for classification purposes. It is known that existing vibratory source elements have a piston or flextensional shell that is physically displaced over a length L for generating a frequency f. All these vibratory source elements share the fact that the displacement length L imposes a low frequency constraint on how much sound pressure can be generated. Because sound pressure is directly proportional to volumetric acceleration for a monopole, then a piston vibratory source will have a maximum achievable sound pressure output level that is inverse proportional with the square of the generated frequency f if the piston is driven to its limits at low frequency. In other words, the maximum achievable sound pressure falls rapidly as the frequency decreases. Most of the embodiments to be discussed next will describe a source element that modulates a fluid flow. These source elements are called herein fluid flow-modulated source elements, to distinguish them from traditional vibratory and impulsive source elements. Modulating a fluid flow is akin to changing the fluid volumetric velocity of a monopole. Fluid flow-modulated devices tend to be subject to flow rate constraints as opposed to displacement constraints, so that the maximum achievable sound pressure output level is inverse proportional with the frequency when operated under a flow rate constraint. In summary, for operation at low frequency, conventional sources have outputs that fall as the inverse square of frequency while fluid flow-modulated source elements have outputs that fall only as the inverse of frequency. When there is no reason for confusion, these novel fluid flow-modulated source elements are simply called source elements.

The fluid flow-modulated source elements can be classified as active and passive source elements. For example, a fluid flow-modulated source element that achieves a net (i.e., non-zero) fluid flow is considered to be an active source element, while a source element that achieves a zero average fluid flow is considered to be passive source element. In one embodiment, the net fluid flow is constant. For the net fluid flow source elements, a net amount of water or other medium passes through a body of the source element, while for a zero average fluid flow source element, no net amount of water or other medium passes through the body of the source element. In some embodiments, the zero average fluid flow source elements fully contain the water or other medium inside their bodies and do not fluidly communicate with the environment. Another distinguishing characteristic is that passive fluid flow-modulated source elements can provide sound pressure output while in a stationary position, while active fluid flow-modulated source elements have to be towed through the water to provide sound pressure and the towing velocity can affect their output.

In one embodiment, the fluid flow-modulated source elements are towed devices that operate at moderate depth (e.g., 10 to 100 m) and act as an acoustic monopole suitable for use over the frequency range of 1-5 Hz. Other frequencies are possible, and the descriptions/concepts presented herein can be applied to adapt the fluid flow-modulated source elements to operate over other frequency ranges. The low-frequency acoustic monopole source can be realized in different ways. Active source elements achieve fluid flow by being towed through water by a vessel, and the input fluid flow is later modulated by a flow-modulator mechanism to create a dynamic pressure fluctuation at its outlet. The passive source elements may use an oscillatory pumping action created by, for example, a propeller, impeller, pump or other means to effectively dynamically inject and/or extract a volume of water.

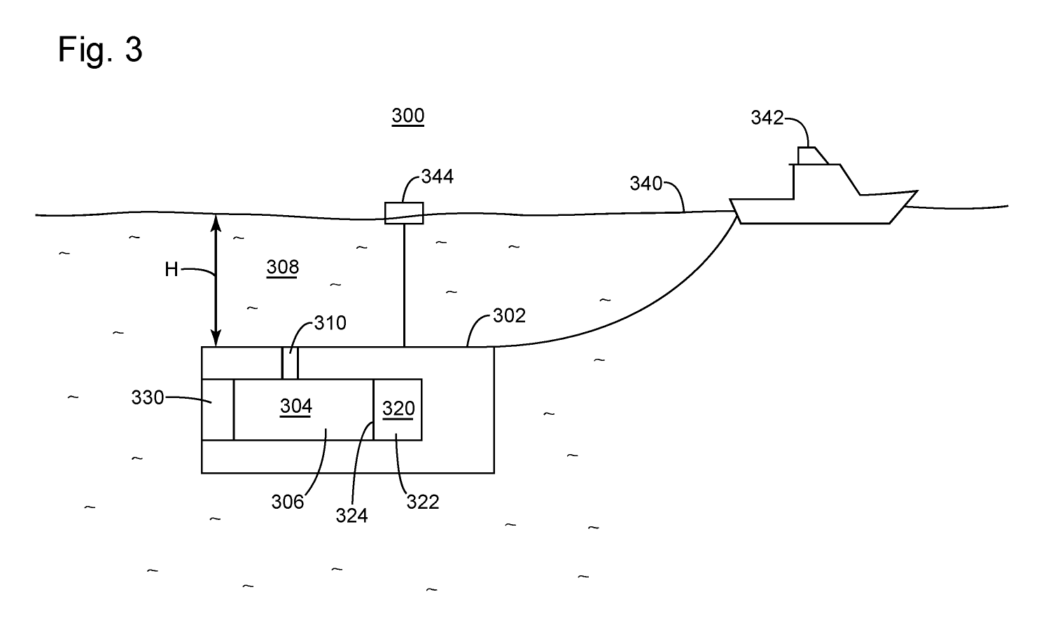

Both passive and active source elements 300, as illustrated in FIG. 3, may include a housing 302 configured to include a hydraulic reservoir compartment 304 that contains a volume of liquid 306. The hydraulic reservoir compartment may be open to environment 308 (e.g., water, air above the sea, etc.) through a passage 310. However, some of the embodiments will describe the hydraulic reservoir compartment as not being in fluid communication with the environment 308. Source element 300 also includes a compliant compartment 320 with a trapped volume of gas 322, either contained in a trapped air pocket, or which may employ other means to provide a moveable barrier 324 between the liquid 306 and gas volume 322. Gas volume may include air, nitrogen, or a noble gas. The moveable barrier may be, for example, a sliding piston, elastic membrane, bladder, corrugated membrane, diaphragm, bellows or other suitable means. Note that a dedicated actuator, such as a motor or electromagnet, does not actuate the moveable barrier 324, as is the case with a conventional source element.

Source element 300 also includes a flow modulator 330 that can be a propeller, flow diverter, flow restrictor, orifice or other means that allow the rate of fluid flow passing the flow modulator to be varied. In one application, the flow modulator fluidly communicates with environment 308. Trapped gas 322 acts as a compliant volume, increasing (decreasing) in size as liquid 306 is removed from (injected into) the hydraulic reservoir compartment. The effect of the trapped gas 322 is to increase the effective compliance of the liquid supply volume contained in reservoir 304. Source element 300 is configured to be towed under the water surface 340, at a given depth H, by vessel 342. In one application, source element 300 may be attached to a float 344.

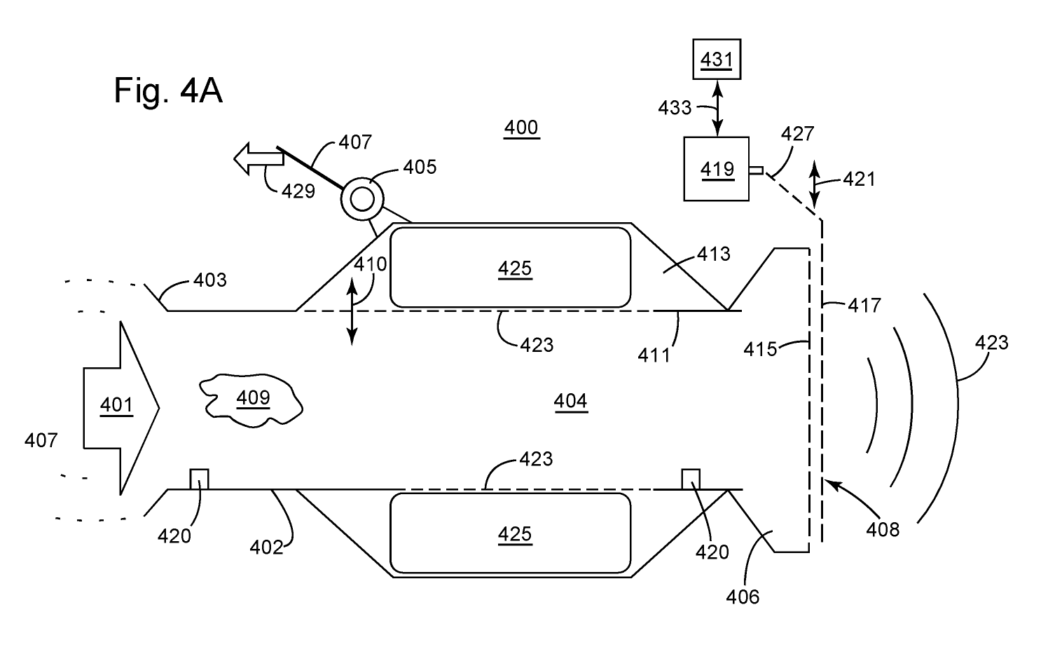

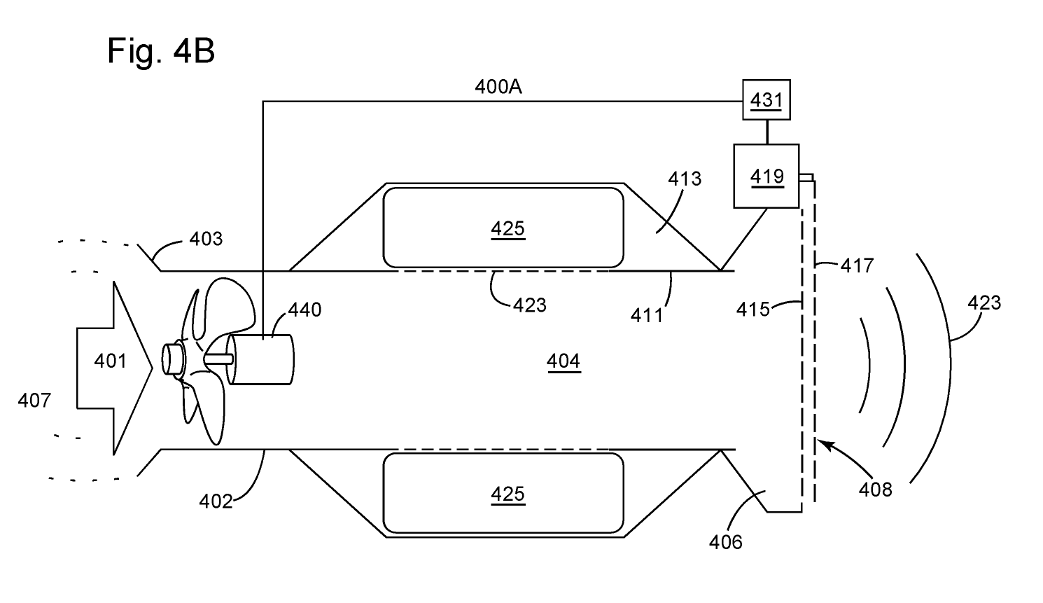

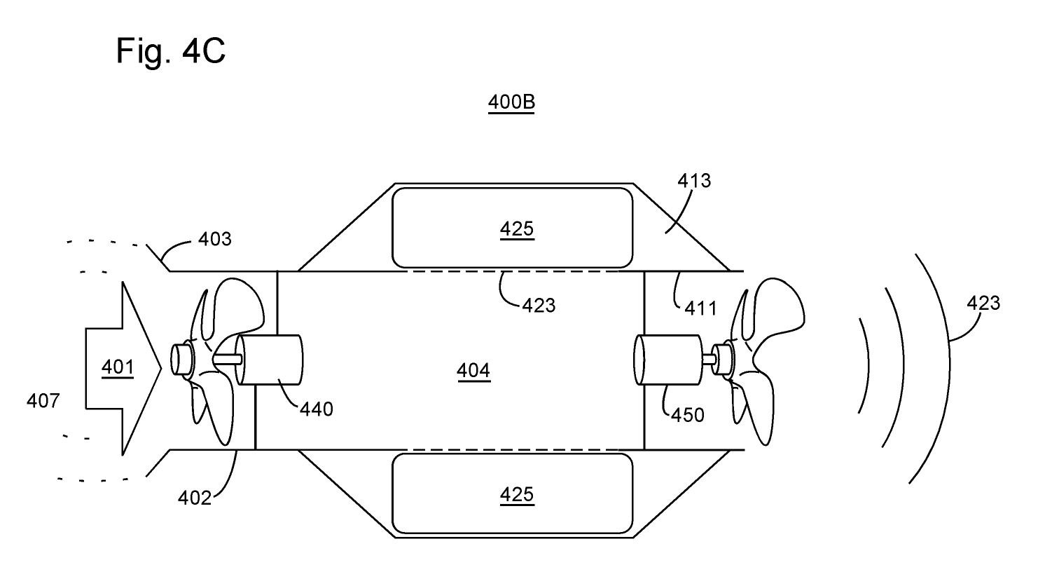

The various net fluid flow-modulated source elements are now discussed with reference to FIG. 4A. A cutaway profile of source element 400 is shown. Net fluid flow-modulated source element 400 (called herein “source element” for simplicity) may have an overall cylindrical housing 402. Source element 400 is pulled by a seismic vessel (not shown) traveling in direction 429 via a cable or other means 407 that is connected to housing 402 by an eyebolt 405 or equivalent structure.

As source element 400 is towed along direction 429, ambient fluid 407 enters throat or inlet 403, which may or may not have a funnel shape to act as a fluid ram to increase the inlet pressure. The resulting fluid flow 401 enters throat 403 and moves down along a passage 404 inside source element 400. At the exit point 406 of passage 404, which may be a hollow cylinder, a flow restrictor 408 is located. In one embodiment, flow restrictor 408 includes two slotted plates 415 and 417. Plate 415 is rigidly attached to housing 402, while plate 417 rides inside a track so that it can slide vertically or horizontally with respect to plate 415. Plate 417 is also attached to an actuator 419 through linkage mechanism 427. A controller 431, located on the vessel or on the source element or distributed both on the vessel and the source element, is in communication with actuator 419 through communication link 433, which can be an electrical connection, so that actuator 419 causes plate 417 to slide relative to plate 415. For example, controller 431 may cause plate 417 to move vertically up and down to follow, for example, a sinusoidal motion 421. Motion pattern 421 may be loaded by the source operator into controller 431. Other motion patterns may be used.

As plate 417 slides relative to plate 415, fluid flow 401 experiences a variable restriction so that, for example, when the slots of the two plates are misaligned, i.e., the flow is restricted, a back pressure will be created due to the momentum of the flow traveling axially. When the plate's slots are aligned, the restriction is removed and there will be a pressure drop inside passage 404. In order to absorb this back pressure or water hammer effect, a compliant compartment 413 is created. Compliant compartment 413 in this embodiment is a circumferential rigid-walled compartment that houses one or more gas-filled bladders (for example an inner tube) 425. Bladder 425 may directly interact with the fluid 409 inside passage 404 through circumferential screen 423. Circumferential screen 423 may be attached to walls 411 that define passage 404. Circumferential screen 423 may also be used to maintain gas-filled bladder 425 inside compartment 413. When properly inflated for the operating depth H, gas-filled bladder 425 only partially fills compartment 413. In one application, the gas volume is about 40-60% of the total compliant compartment volume. The volume of fluid 410 flowing into and out of compartment 413 is the supply and or replacement volume needed to make up for the deviation in exit flow rate created by the variable restriction caused by plates 415 and 417.

The fluid volume 409 in passage 404 will tend to act like a fluid mass. Because the gas-filled bladder 425 is more compliant to the pressure perturbations in passage 404 than the inertia presented by the slug of fluid 409, compartment 413 effectively acts like a hydraulic accumulator that tends to reduce pressure disturbances within passage 404. The net result is that at outlet 406 and to the right of screen 417 in FIG. 4A, pressure perturbations are created due to flow modulation resulting in acoustic pressure waves 423 that radiate into the ambient 407, while at throat 403 the pressure perturbations created by varying the flow restriction created by sliding plate 417 are damped due to the action of circumferential bladder 425.

For bladders 425 to function properly over the desired frequency range of 1-5 Hz, their volume as well as the volume of compartment 413 needs to be sized appropriately and properly inflated. Also, it is necessary that the axial length of passage 404 from throat 403 to flow restrictor 408 be sufficient to contain the slug of water 409 whose mass in combination with the spring rate of gas-filled bladders 425 has a resonance that is at or below the operating frequency.

FIG. 4B shows another embodiment of an active source 400A in which a substantially constant fluid flow 401 is achieved with a motor 440. Motor 440 may have a fixed speed and it is controlled by controller 431. In another embodiment illustrated in FIG. 4C, active source 499B has a second motor 450 located inside passage 404, for replacing flow restrictor 408. Second motor 450 may have variable speed and/or variable pitch so that it can modulate the flow rate exiting passage 404.

If passage 404's length is inadequate, then the pressure perturbations at the throat due to the change in exit restriction will tend to make the device behave more like a dipole than a monopole acoustic source, which is undesirable for this application.

In one application, transducers 420, such as flow measuring devices, pressure transducers or other sensors, could be used to provide feedback or monitoring signals to controller 431 or send information via a telemetry system (not shown) to the recording system located on the seismic vessel for later use in seismic data processing.

Instead of sliding slotted plates as illustrated in FIG. 4A for modulating the fluid flow 401, other means could be used to create the variable restriction. For example, plates 415 and 417 may be designed with radial slots so that plate 417 may be rotated relative to plate 415 to vary the open slot area to produce a variable restriction to the exiting flow. Other modulation schemes like a rotating horizontal damper (or louvers) with an elliptical profile could be employed so that as they were turned, the closed area perpendicular to the axial flow could be varied. Another option might be to have a propeller with either fixed or variable pitch that is driven by a motor so that the pitch of the blades in combination with the motor shaft speed could either reinforce or brake the exit flow to create a pressure perturbation at the exit point. Those skilled in the art would appreciate that many other mechanisms may be used to modulate fluid flow.

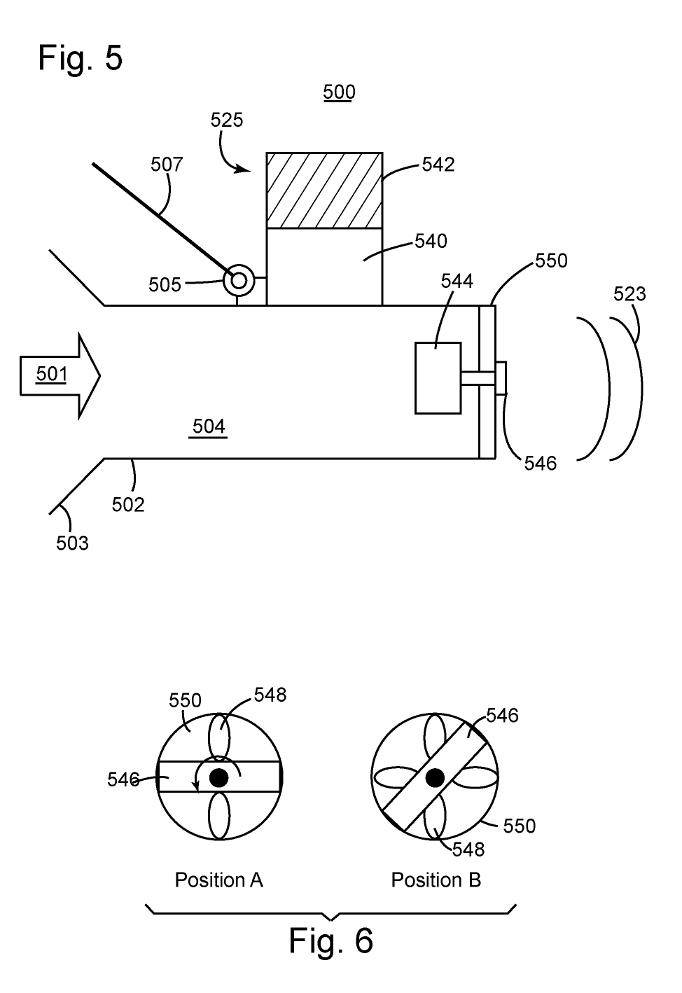

Further, other mechanisms may be used instead of circumferential air bladder 425 to create an effective hydraulic accumulator as shown in FIG. 5. A vertical water column 540 with an air pocket 542 trapped above it could act as accumulator 525. For this case, a motor 544 is shown turning a bar 546. As it rotates, bar 546 blocks various slots or holes 548 in an orifice plate 550 to vary the restriction experienced by the exiting fluid. In this embodiment, a single rotation of the bar could create two full cycles of fluid exit pressure fluctuation as illustrated in FIG. 6. The restriction need not fully block the fluid flow to create low-frequency sound pressure waves 523. Other modifications to the active source element 400 or 500 may be easily implemented by those skilled in the art.

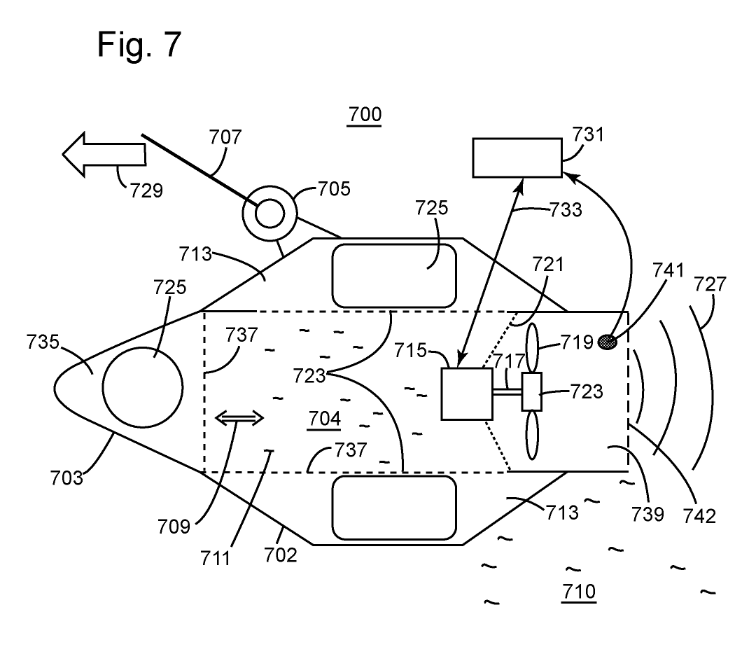

A passive source element 700 (i.e., a source element that achieves zero net fluid flow) is now discussed with regard to FIG. 7. Parts of source element 700 that are similar to those of source element 400 are only briefly described herein. Source element 700 is the equivalent of a passive acoustic monopole. The source element has a rigid shell 702 and is towed with a cable 707 (umbilical) at a predetermined depth by a seismic vessel (not shown) moving along direction 729. Cable 707 or other means is connected to shell 702 by an eyebolt 705 or other fastener. Source element 700 is open to the ambient 710 at one end 739 and may have a conical-shaped closed end 703 as shown in FIG. 7. Other hydrodynamic features, not shown in FIG. 7, are possible such as fins or control surfaces to reduce drag and improve position control.

An interior chamber 704 of housing 702 is flooded with a fluid 711 that is in communication with the ambient 710 (e.g., seawater). Propeller 719, impeller, or another device is driven by a rotary actuator (e.g., motor) 715 for generating a fluid flow 709. Rotary actuator 715 may be attached to shell 702 via some ribs 721 or other means that support actuator 715, but do not unduly restrict the exchange of fluid between interior chamber 704 and the ambient. Propeller 719 is connected to hub 723, which may contain devices to vary the pitch of the propeller vanes. Actuator 715 connects to hub 723 via a rotating shaft 717. Actuator 715 can be a torque motor operating over a fixed angular range of travel; it can be a brushless servomotor with a permanent magnet rotor (for example, a neodymium iron boron magnet) and a field winding that is in communication through link 733 with controller 731, which may contain a power amplifier. Link 733 can be a two-way link; for example, actuator 715 may be equipped with feedback devices like a tachometer useful for measuring shaft velocity or a shaft encoder to measure shaft position and whose signals could be received by controller 731 to aid with control. Additional transducers 741, for example, flow sensors or pressure sensors, could be located in outlet region 739 to monitor output signals that could also be used as feedback signals for controller 731. In one application, actuator 715 may be a pneumatic motor or a hydraulic motor, in which case controller 731 might contain servovalves, and link 733 may contain hydraulic or pneumatic lines as well as electrical cables.

Shell 702 may contain accumulator compartments 713 that are circumferential or other compartments 735 that house one or more gas-filled bladders 725. These compartments function as hydraulic accumulators, and the gas-filled bladders expand or contract in volume as water is pumped in and out of interior chamber 704 due to the action of propeller 719. At a given depth, when the propeller is stationary, the accumulator compartment volume is about half water and half gas. The liquid in compartments 713 and 735 is in fluid communication through a screen 737 with liquid 711 that is in the interior chamber 704 of shell 702. The hydraulic accumulators act as a soft spring so that the liquid can more easily be pumped in and out of the housing's interior chamber 704 as propeller velocity changes.

If actuator 715 is a servomotor, it can be variable-speed and reversible. The volume of liquid that propeller 719 injects into or extracts from the surrounding ambient 710 over an interval of time is a function of the propeller's pitch, shaft velocity and the pressure gradient between interior chamber 704 and outlet region 739.

Propeller 719 can have a fixed pitch, variable pitch and/or reversible pitch. Several operational options are possible for such a system:
1) Actuator 715 could be operated at a constant velocity, and the pitch of propeller 719 could be varied when commanded by controller 731 to produce a variable outlet flow. The variable outlet flow gives rise to pressure perturbations at outlet region 739, which radiate into the surrounding ambient as seismic signal 727.
2) Propeller 719 could have fixed pitch, and controller 731 may command actuator 715 to vary its speed and/or direction, so that the resulting pressure perturbations at outlet region 739 follow a target signal.
3) Propeller 719 could rotate always in the same direction to create a static pressure increase in interior chamber 704 that is slightly above the hydrostatic pressure in the surrounding medium. The amount of interior pressurization that could be achieved would be limited by the leakage past the propeller. The speed and/or pitch of propeller 719 could be varied so that fluid could be injected for a limited time (the time interval determined by the capacity of the hydraulic accumulator) into the surrounding medium, if the propeller's speed or pitch were reduced. Likewise, if propeller speed or pitch were increased, fluid would be pulled in from the surrounding medium 710 and tend to reduce the pressure in the surrounding medium 710 and at the same time increase the pressure of the liquid contained inside the source element and inside the hydraulic accumulator compartments. The injection or extraction of fluid results in pressure perturbations in outlet region 739, which produce seismic signals 727 that radiate into the surrounding medium; and
4) Other variations of motor speed or propeller pitch that result in pressure perturbations at outlet region 739 that result in seismic signals 727.
5) Instead of having the fluid inlet/outlet exiting through a single rear port, the single open port as shown could be blocked and replaced by a number of ports circumferentially arranged near the rear of the device, so that the fluid enters/exits radially to better balance reactive forces created by the fluid motion.

A screen or guard 742 may be located at outlet region 739 to allow for the free exchange of fluid between acoustic outlet region 739 and the propagating medium 710 to help filter out any debris or to prevent marine life from entering the source element. Such a guard could also be included in the sources discussed in the previous embodiments.

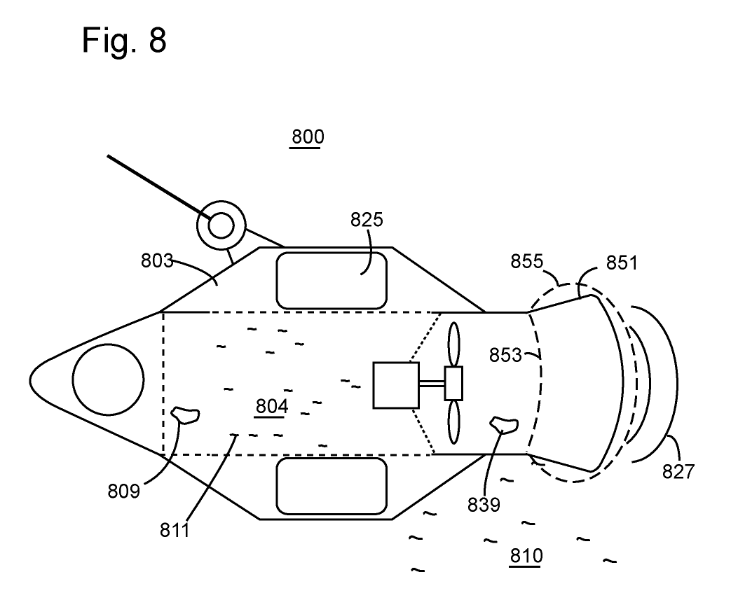

For the case where the source element is configured so that the same amount of fluid just flows back and forth (i.e., zero net fluid flow source element), it may be possible to cover outlet region 739 with a membrane or rubber boot as now discussed with regard to FIG. 8. FIG. 8 shows this option, with a boot 851 located at outlet region 839. Boot 851 may be made of any flexible material, for example, rubber. An internal propeller guard 853 may be provided next to the propeller to keep boot 851 away from the propeller. There is an option to have another guard 855 on the outside of boot 851 to keep it from stretching too far or to protect it from damage. Boot 851 acts as a barrier to keep dirt and debris out of interior chamber 804. Since the interior working fluid 811 is separated from the ambient 810, working fluid 811 could be something less corrosive than seawater, for example, fresh water, mineral or vegetable oil, or just filtered seawater. Thus, in one application, ambient fluid 810 is different from working fluid 811. Instead of a membrane or boot 851, a bellows or piston could be used.

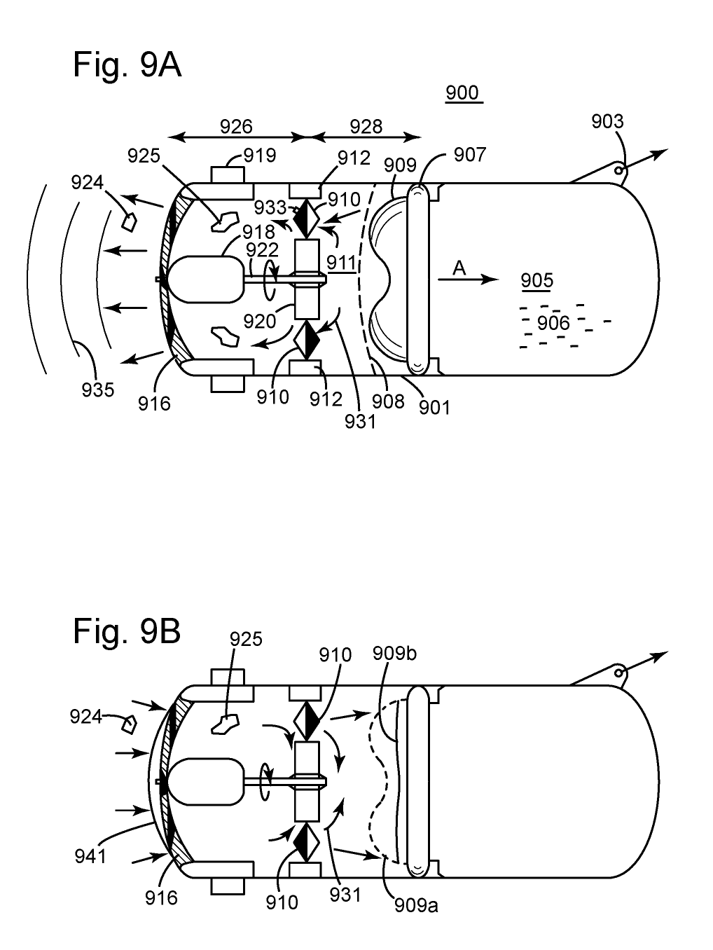

Other passive source elements are possible that allow for partitioning of pitch control and propeller rotation mechanisms, as are now discussed with regard to FIGS. 9A-B. FIGS. 9A-B show a source element 900 towed by a vessel via cable 903. Source element 900 has an enclosure 901 that hosts a compliant chamber 905. A gas volume 906 is housed inside compliant chamber 905. Compliant chamber 905 is fluidly isolated from a working chamber 911 by a flexible barrier (e.g., a diaphragm) 909. Flexible barrier 909 may be held in place relative to housing 901 with a circumferential sealing mechanism 907. Flexible barrier 909 may be rubber reinforced with fiber (glass, polyester or Kevlar, for example) to limit the amount of gas volume expansion. A screen 908 may be placed in region 928 of working chamber 911 to act as a barrier guard.

A sealed actuator 918 (e.g., a motor) suitable for underwater operation is powered and controlled by controller 919. Controller 919 may be located on housing 901 (inside or outside it), or on the vessel towing the source, or it may be distributed on the vessel and source element 900. Actuator 918 may have a shaft 922 that drives a paddle wheel 920, for example, at constant rotations per minute (rpm). Paddle wheel 920 imparts rotational kinetic energy to internal fluid 925. In one application, a variable speed motor may be used. Actuator 918 is attached to enclosure 901 through a structural support device 916 that may be, for example, a system of radial ribs covered by a screen or grate that blocks large debris but allows for the exchange of fluid between the ambient liquid media 924 and the internal fluid 925 of working chamber 911. Note that FIG. 9A shows working chamber 911 having two regions 926 and 928, which are divided from each other by paddle wheel 920. The two regions 926 and 928 are in fluid communication with each other. Torque-producing devices (e.g., servomotors, torquemotors, synchros or others devices capable of producing torque over some angular range) are arranged around the inner circumference of enclosure 901 and rigidly attached to it. Each torque-producing device 912 may be connected to one or more flow diverters or vanes 910, whose axis of rotation is in radial alignment and perpendicular to the central axis A of enclosure 901.

With this mechanism in place, the source element's operation is now described. Paddle wheel 920 spins the fluid near it, imparting rotational kinetic energy to internal fluid volume 925. Controller 919 controls actuator 918 to generate the necessary spinning. Vanes 910 can be rotated by corresponding torque-producing devices 912 to transform part of the rotational kinetic energy into translational energy so that fluid flow 931 moves (translates) either to the left as shown in FIG. 9A or to the right, as shown in FIG. 9B. Vane rotation is also controlled by controller 919. In effect, the vanes act much like a propeller equipped with reversible pitch control. The angular position of vanes 910 along the internal circumference of housing 901 can be used to adjust both the amount and direction of the fluid flow. For example, if it is desired to generate a 1 Hz signal for a portion of the cycle, vanes 910 would be directed as shown in FIG. 9A, then move in a controlled fashion to a neutral position producing no axial flow (not shown) so that the rotational kinetic energy of the internal fluid is replenished, and then to a position as shown in FIG. 9B to generate the translational fluid flow, then back to the neutral position, and then back to the position shown in FIG. 9A, and so on. Controller 919 controls all these positions. Vanes 910 may be equipped with position sensors 933 (only one shown for simplicity; for example, RVDTs or shaft encoders or other known sensors) that can be used to provide feedback signals to controller 919.

Similar to the other active flow-modulated source elements discussed above, as the translational fluid flow is directed to the left as shown in FIG. 9A, the liquid in regions 926 and 928 and, at the same time, barrier 909 moves to the left, and the gas volume 906 inside chamber 905 expands, generating acoustic waves 935. When the flow is redirected inward, to the right as shown in FIG. 9B, barrier 909 moves from position 909a to 909b (see FIG. 9B) and gas volume 906 is reduced to make room for the water entering the enclosure. Optionally, guard 916 may have an elastic cover 941 to isolate regions 926 and 928 from contamination. Elastic cover 941 then may prevent ambient fluid 924 from entering inside housing 901. For this case, internal fluid 925 within working chamber 911 may be distilled water, oil or filtered seawater, for example. The elastic cover would allow acoustic energy transfer while blocking the mixing of internal fluid 925 with ambient fluid 924.

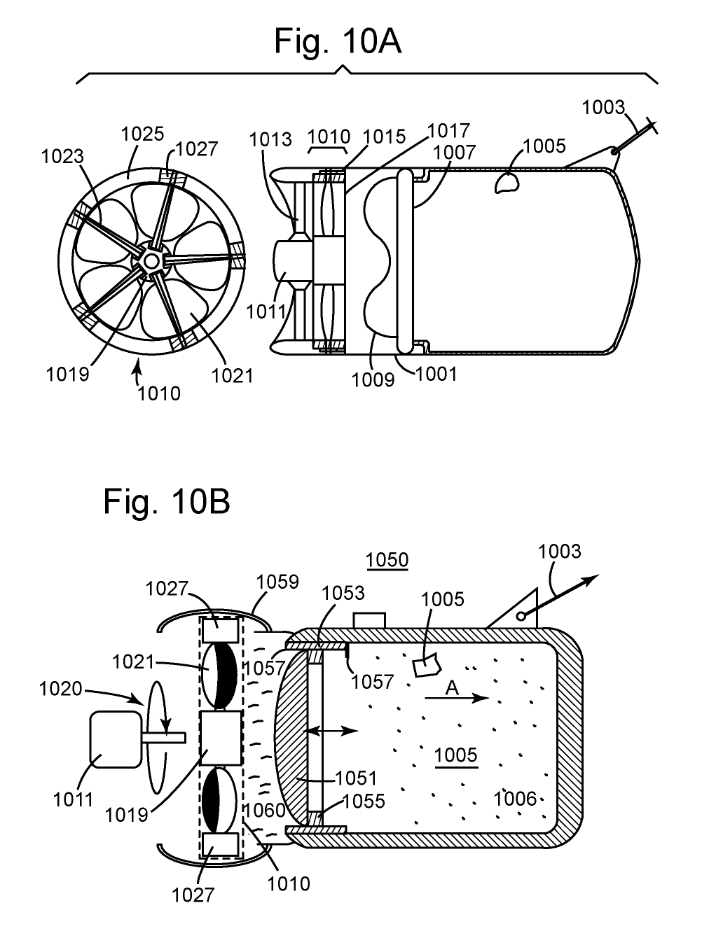

Variations of source element 900 are now discussed with regard to FIGS. 10A-B. In this embodiment, source element 1000 has enclosure 1001, compliant chamber 1005, and barrier 1009 with seal 1007 similar to source element 900. In this case, a rotating assembly 1010 (e.g., having a diameter of about 2 m) is turned by motor 1011 inside enclosure 1001 and may be supported by bearings 1015 located between enclosure 1001 and rotating assembly 1010. Motor 1011 is rigidly attached to enclosure 1001 using any appropriate structure (e.g., ribs) 1013. An end view of assembly 1010 shows some of its components: rim 1025 that contains, for example, five vane drivers 1027 (vane drives can be servomotors, synchros or torquemotors equipped with angular position sensors), each of which drive a vane shaft 1023 connected to vanes 1021.

Each vane shaft 1023 is connected to a central hub 1019, which can contain vane shaft bearings to allow for the free rotation of vanes 1021 by vane drivers 1027. Additional spoke elements 1017 are used to transmit the torque generated by motor 1011 to assembly 1010 (the spokes are not shown in the end view of 1010). Assembly 1010 acts as a variable-pitch propeller. Electrical connections to vane drivers 1027 can be made, for example, by running wires down the spoke elements 1017, to hub 1019, which in an embodiment might be equipped with slip rings to make an electrical connection to the vane/pitch controller. Motor 1011 could be operated at a constant rpm, for example, 300 rpm, with vane drivers being 1.5 kW servomotors or gearmotors. By changing the pitch of vanes 1021, water can be directed into or ejected from enclosure 1001 as in other embodiments.

In another embodiment, motor 1011 could be offset from the center of the housing, instead of being located at the center of the fluid outlet. For example, motor 1011 may be located on the exterior of enclosure 1001, and a suitable drive motor coupling system, for example, chain drive, pulley system, gears, flexible shaft or other means, could be used to connect drive motor 1011, in which case, assembly 1010 might be equipped with a sprocket, gear, pulley or other compatible device.

FIG. 10B shows another source element 1050, similar to that shown in FIG. 10A. Both source elements 1000 and 1050 include a rotating assembly 1010 driven by motor 1011, which may typically run at a constant rpm, for example, 300 rpm. Motor 1011 has a shaft that rotates about the central horizontal axis of the source element. Rotating assembly 1010 rotates inside fairing 1059 in the embodiment shown in FIG. 10B. Fairing 1059 may be shaped to reduce the drag of the propeller and/or improve performance, for example, to increase maximum achievable flow rates. The flow modulator system 1020 for this embodiment is a propeller equipped with variable and/or reversible-pitch vanes or blades 1021. Pitch-control drivers 1027, shown located around the circumference of assembly 1010, drive vanes 1021. Pitch-control drivers 1027 alternately could be located within hub 1019. Note that source element 1050 uses a sliding piston 1051, which moves linearly along axial direction A, instead of a flexible barrier as in source element 1000. Piston 1051 may be equipped with dynamic seal 1055 (can be a bushing, lip seal, ring, bellows seal, rolling seal or other means) and rides inside of sleeve 1053, which may be equipped with piston stops 1057. Piston stops 1057 may be rigid stops or bump stops that have a shock-absorbent facing, for example, rubber or polyurethane. Thus, if the pitch of vanes 1021 is in a position to create a fluid flow exiting the source element, piston 1051 will slide to the left and the compliant chamber 1005, filled with gas 1006, will increase in volume. If the pitch of vanes 1021 is reversed to create a fluid flow into the source element, then piston 1051 will slide to the right and the volume of chamber 1005 will decrease to accommodate the increase in the liquid volume 1060.

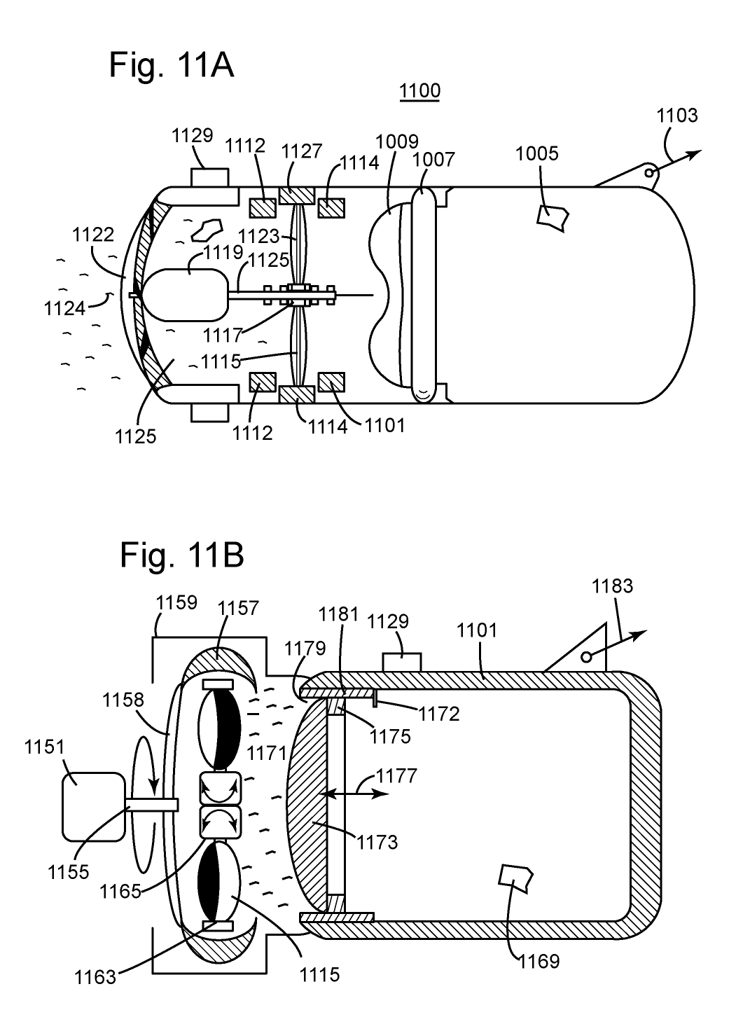

An alternative source element 1100 is now discussed with regard to FIG. 11A. Source element 1100 is similar to source element 900, but instead of having a center paddle wheel, this source element has two paddle wheels 1112 and 1114 equipped with vanes arranged circumferentially. Paddle wheels 1112 and 1114 are rotated in one embodiment at a constant rpm by motor 1119 to produce a circular water flow in the region of vanes 1115. Vanes 1115 are driven by vane drivers 1127 via radial vane shafts 1123 connected to vane drivers 1127 at one end and to vane hub 1117 at the other end. Vane hub 1117 may be stationary, and it may contain bushings or bearings to receive radial vane shafts 1123 and allow for the free rotation of vanes 1115 by vane drivers 1127. Vane drivers 1127 may be equipped with position sensors used to provide feedback to a controller 1129. As before, by changing the pitch of vanes 1115, the axial fluid flow can be directed outward or inward from housing 1101 through motor support structure 1121. Motor support structure 1121 may be constructed of radial ribs equipped with a guard, grating or screen 1122 to keep debris from entering the housing. As before, housing 1101 could be filled with a clean liquid and, in that case as in other embodiments, a cover 1127 (e.g., a membrane) that allows for adequate fluid volume perturbations is located next to the motor support structure 1121. If cover 1127 is present, internal fluid 1125 is insulated from external fluid 1124, and the two fluids can be different.

Another source element 1150 is illustrated in the embodiment depicted in FIG. 11B. Source element 1150 has vane pitch drivers 1165 connected to housing 1101 (connecting support structure not shown) and located near the central axis of the source element. Vane pitch drivers 1165 move vanes 1115 through a limited range of angles with the vanes' axis of rotation being perpendicular to the central axis of housing 1101. Each vane may be equipped with pitch angle sensor 1163, which may be used as feedback and/or monitor signals by controller 1129. Rotating paddles 1157 are connected to drive shaft 1155 and actuator 1151 via a connecting structure 1153, for example, ribs or another suitable structure that will not restrict axial liquid flow. Paddle vanes 1157 and fairing 1159 may be suitably shaped to improve hydrodynamic performance. As the pitch of vanes 1115 is changed, sliding piston 1173 rides inside sleeve 1181, which is mounted on housing 1101. As piston 1173 slides axially along direction 1177 to the left (right) due to fluid being directed outward (inward) by vanes 1115, the gas volume 1169 increases (decreases) to accommodate the decrease (increase) in fluid volume 1171. As before, piston 1173 may be equipped with seals 1175 and stops 1172. A seismic vessel using tow cable 1183 may tow this source element at a desired depth.

Those skilled in the art would understand that other configurations of the source elements discussed above are within the scope of the invention as long as low frequencies are generated by modulating a fluid flow to produce a fluid volumetric velocity with a resultant sound pressure signal emission. As also discussed in the previous embodiments, there is no directly driven piston or shell that moves the fluid flow, unlike traditional source elements. Fluid flow may be achieved by towing the source element with opposite ends open to the ambient so that the fluid flow passes through the source element or, by moving in an oscillatory manner, a volume of water is housed by the source element so that the moving volume of water impinges on the flexible end or directly on the ambient to generate acoustic waves. For the latter case, rotational kinetic energy may be imparted to the volume of water by the action of paddles or other devices. Thus, for this case, after rotational kinetic energy is imparted to the water volume, the water volume is made to move along a longitudinal axis by transforming part of the rotational kinetic energy into translational energy. This translational energy is impinging on a flexible cover or directly on the ambient medium to generate the acoustic waves. The rotational kinetic energy is “stored” in the water volume and then “discharged” into the ambient at desired instants to generate the desired low frequency. Those skilled in the art would appreciate that a volume of about a couple of cubic meters of water may be used inside the source element for achieving the low frequencies.

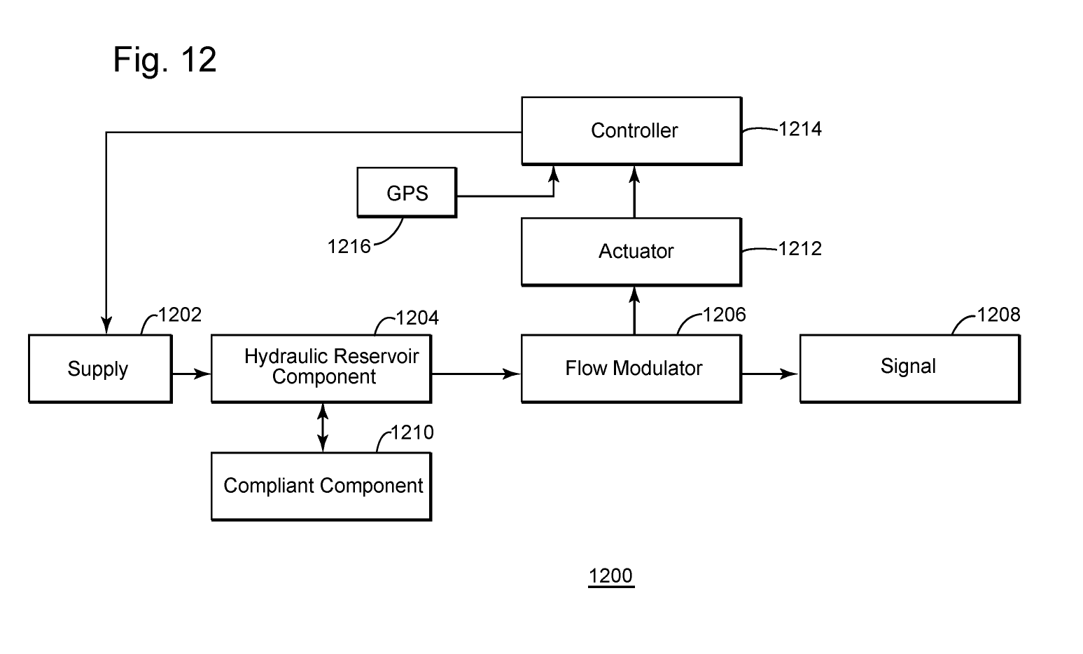

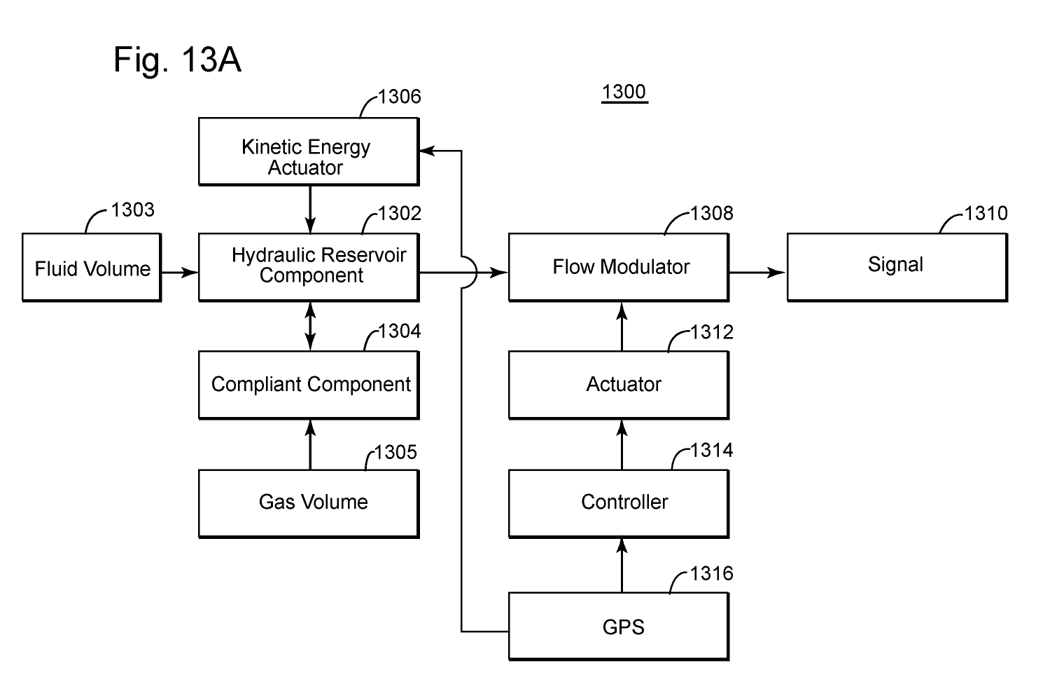

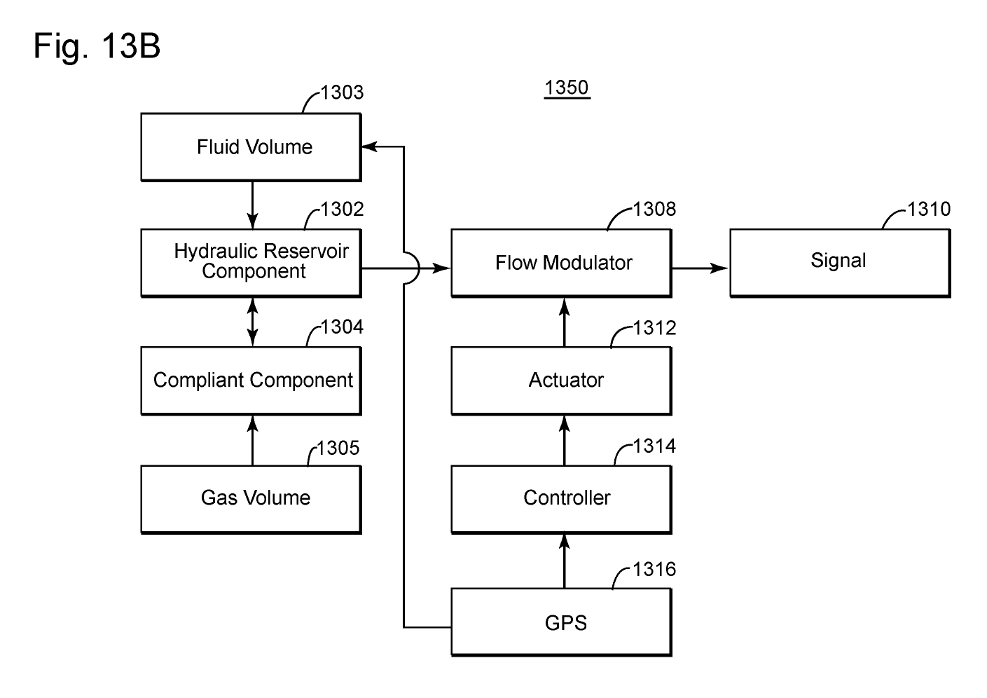

Passive and active source elements as discussed above illustrate some of the possible embodiments. Many other embodiments may be imagined that will not depart from the principles of the passive and/or active source elements discussed above. These principles of passive and active source elements may be illustrated in block diagram style as now discussed with regard to FIGS. 12 and 13. FIG. 12 shows the block diagram for an active source element, while FIG. 13 shows the block diagram for a passive source element.

With regard to FIG. 12, active source element 1200 includes a supply block 1202 that supplies water to the hydraulic reservoir component 1204 of the source element (see, for example, source element of FIG. 4). The function of the supply block 1202 may be achieved by simply towing the source element under water with its opposite two ends open, as illustrated in the FIG. 4 embodiment. Fluid flow created by supply block 1202 through hydraulic reservoir component 1204 is then modulated by flow modulator mechanism 1206 to generate a desired low-frequency signal 1208. The fluid flow will experience times of fast flow and times of slow flow, which are accommodated by compliant component 1210. Flow modulator mechanism 1206 may be actuated by an actuator 1212, which is controlled by controller 1214. Controller 1214 may also control supply block 1202. Various sensors discussed in the above embodiments may be located in any of these modules, and these sensors are connected to controller 1214 to provide feedback. Controller 1214 may be a computing device, to be discussed later, that accepts instructions from a user. Controller 1214 may be programmed to generate one or more low frequencies, for example, at desired locations along a preplot. A Global Positioning System (GPS) 1216 may be part of source element 1200 for generating the coordinates of the desired locations to shoot the source element along the pre-plot. Those skilled in the art would recognize that not all the modules shown in FIG. 12 are necessary for a functional source element.

The block diagram for a passive source element is now discussed with regard to FIGS. 13A and 13B. One noticeable difference compared to the active source is that no fluid supply is necessary. In other words, a given volume of fluid, which may be stored inside source element 1300, is pushed back and forth during the operation of the source element to generate seismic waves. FIG. 13A shows source element 1300 having a hydraulic reservoir component 1302 that interacts with a compliant chamber 1304, as disclosed, for example, in FIGS. 9A to 11B. Hydraulic reservoir component 1302 holds fluid volume 1303, while compliant chamber 1304 holds gas volume 1305. A rotational kinetic energy actuator block 1306 imparts rotational kinetic energy to the fluid volume 1303 present inside hydraulic reservoir component 1302. Rotational kinetic energy actuator block 1306 may include a paddle as in the embodiments illustrated in FIGS. 9A, 9B, 11A and 11B. A flow modulator component 1308, which may be located inside hydraulic reservoir component 1302, transforms the rotational kinetic energy into translational energy so that part of the fluid volume translates along one or more axes of the hydraulic reservoir component 1302 to move or deform at least one wall (e.g., wall of the compliant chamber) of the source element. That wall may be or not be sealed against the ambient fluid, i.e., the ambient fluid may be allowed to enter hydraulic reservoir component 1302. The deformation of the wall or the escape of the fluid volume outside the source element generates a signal 1310 having a desired low frequency.

The desired low frequency is achieved by using an actuator 1312 that transforms the rotational kinetic energy into translational energy. Controller 1314 may control actuator 1312 and rotational kinetic energy actuator 1306. This controller may also receive information from one or more sensors distributed throughout the source element. Similar to source element 1200, source element 1300 may use a GPS system 1316 for receiving location information and correlating the instant when to shoot the source element with the seismic survey pre-plot.

FIG. 13B illustrates another source element 1350 that does not generate rotational kinetic energy. For this reason, there is no kinetic energy actuator 1306 in FIG. 13B. Source element 1350 has hydraulic reservoir component 1302 and compliant component 1304, as illustrated in FIGS. 7, 8, 10A and 10B. A flow modulator 1308 (e.g., propeller with variable pitch) is used to move back and forth fluid volume 1303, thus generating signal 1310.

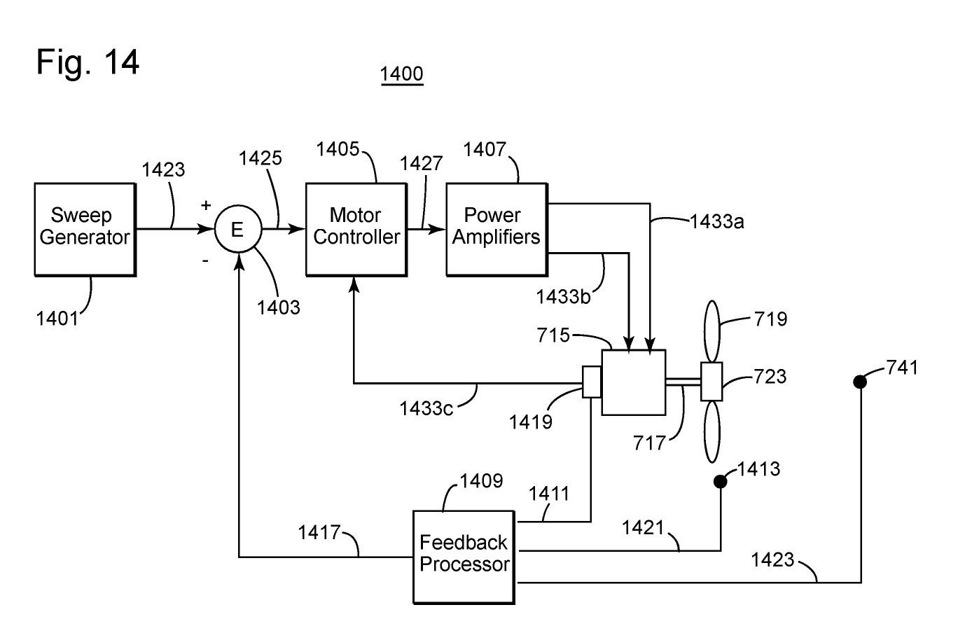

If the flow modulator 1206 or 1308 is a variable pitch propeller, FIG. 14 shows a schematic diagram of a control system 1400 for controlling such a propeller. Control system 1400 could be adapted/configured to operate a sliding or rotating orifice, for example, like those shown in the embodiments of FIGS. 4 and 5. Control system 1400 has a sweep generator 1401 that may be controlled by the vessel's onboard survey management system to produce a sweep signal 1423. Sweep signal 1423 may be a fixed sine, swept sine wave, pseudorandom or other suitable signal. Sweep signal 1423 can be a pilot signal or signal representative of the desired acoustic output to be emitted by the source element.

Comparator 1403 compares feedback signal 1417 to the desired signal 1423 to form an error signal 1425 that is an input to a motor's controller 1405. In one application, feedback signal 1417 is an estimate of the far-field signal formed by combining measured signals 1411, 1421 and 1423 using feedback processor 1409. In one embodiment, feedback signal 1417 is an estimate of the total volumetric fluid acceleration in region 739 in FIG. 7. Signals that come directly from the motor propeller assembly through use of sensors 1419, like tachometers, shaft encoders, etc., suitable for measuring quantities like propeller rotational speed, propeller position, and/or propeller pitch are represented by signal 1411. Line 1421 represents signals from measurements made either in the interior of the fluid flow 709 (this could include sensors inside interior chamber 704) or near the propeller so that they are useful in estimating the volumetric flow in and out of the source element. Corresponding sensors may be located inside interior chamber 704, for example, flow meters (could be anemometer, turbine, Doppler or pitot tube-type sensors) or pressure sensors 1413. Signals 1423 come from transducers 741 (for example, pressure sensors or flow sensors) located in or near outlet region 739.

Motor controller 1405, in addition to signal 1425, may receive feedback signals 1433c from sensors 1419 located in proximity to motor 715, shaft 717 and/or devices to control pitch located within hub 723. Motor controller 1405 combines input 1425 with feedback sensor signals 1433c to produce amplifier drive signal(s) 1427. Drive signals 1427 may in fact be two signals, one to adjust propeller speed and the other for changing the pitch setting. Power amplifier 1407 could be a one or more electrical power amplifiers, since motor 715 could be an electrical motor, but may instead contain servovalves. For example, if motor 715 and pitch control device 723 were hydraulically or pneumatically driven, then power amplifier 1407 might contain both electronic devices for generating electrical signals 1433a for the electronic parts and suitable signals 1433b for hydraulic or pneumatic valves.

From an operational point of view of a low-frequency source element, the arrangement of the towed source element to form a source array is of little consequence so long as its overall dimension is small compared to the wavelength of the sound being radiated. For frequencies in the range of 1 to 5 Hz, corresponding wavelengths are in the range of about 1,500 m down to 300 m. Thus, a source element and/or source array that has an effective acoustic diameter less than 100 m in size is omni-directional, having no directivity when operated in a free-field. The only directivity will be due to the surface reflection. Note that a source element is a single element as discussed above with the embodiments. A source array is understood to include at least one sub-array. One sub-array is understood to include plural source elements.

For the passive monopole (i.e., source element shown in FIGS. 7-11), it may be possible to have an elastic membrane separating interior 711 from seawater; the membrane could be attached across the outlet of device 700. The interior volume could be distilled water or hydraulic fluid. As propeller 719 moves back and forth, the membrane would stretch or retract in response to this action of the propeller.

One advantage of the embodiments discussed herein is that there is no stroke limitation on source elements' output, as is the case for a piston actuator source element, if the compliant component and interior fluid volume are sufficient. For low-frequency operation, stroke limits are typically what constrain the output of the traditional source element. The propeller-driven source element may be limited at higher frequencies by the rotational inertia of the propeller assembly, power/torque requirements and the acoustic radiation mass that will tend to create an increasing inertial load on the propeller as frequency increases. Ultimately, the source element may be limited by the motor current and/or voltage ratings. Also, as propeller velocity is increased, the risk of fluid cavitation increases, and this can lead to erosion of material in the propeller mechanism.

To better understand the peak fluid volume Vpk that is cycled to achieve a certain peak acoustic pressure, refer to equation (1). In this equation, P(r,ω) is the peak pressure in Pascals at a point r, for a monopole source oscillating at frequency ω (radians/s) operating in a free-field with a sinusoidal peak volumetric displacement of V(m³). If the density of the fluid medium is D, typically about 1,020 kg/m³ for seawater, equation (1) is given by:

$$P ( r , ω ) = \frac{D {ω}^{2}}{4 π r} V \qquad ( 1 )$$

To achieve a free-field peak sound pressure level of 4,000 Pa referred to 1 m, in seawater, it requires a peak volume V as shown in equation (2):

$$V = \frac{49.28}{{ω}^{2}} . \qquad ( 2 )$$

To achieve this sound pressure in the free-field for a frequency of 1 Hz, or about 6.28 radians/s, it requires a peak volumetric displacement of 1.25 m³, while to achieve the same sound pressure at 4 Hz, it would only require a peak volumetric displacement of about 0.078 m³. The corresponding peak fluid flow rates would be about 8 m³/s for 1 Hz and about 2 m³/s for 4 Hz. Thus, for the example of an active monopole source, it would need to have an internal liquid volume in excess of these liquid ejection volumes. Furthermore, the gas bladder volumes would ideally need to be greater, and preferably at least twice as big as the peak volumes to be ejected to keep the pressure fluctuations low within the closed shell. For logistical and practical reasons, it is anticipated that a low-frequency source array might be towed behind the seismic vessel, so the total volumetric displacement required to realize a desired sound pressure level would be shared among a plurality of source elements.

For example, if the required total peak volumetric displacement is 1.25 m³ at 1-Hz and a source array including, for example, five source elements is used, each source element would require a peak volumetric displacement of 0.25 m³. The fluid volumetric flow that can be created by a propeller is related to the effective propeller diameter, propeller pitch, motor shaft speed and pressure gradient. Under some simplifying assumptions, for example, comparing 1 Hz and 4 Hz operation of a source element with a fixed-pitch propeller trying to achieve a sound pressure of 4,000 Pa-m at 1 Hz, a peak rotational velocity for 1 Hz would be four times as great as would be required for the same propeller to achieve the same peak sound pressure of 4,000 Pa-m at 4 Hz.

The generated seismic pressure signals are not limited to sinusoidal waveforms. The generated sound pressure waveforms can be a chirp signal with linear or nonlinear frequency versus time profiles, pseudorandom signals or other types. For a monopole source (like the passive or active source elements discussed above), no matter what the low-frequency signal type, the far-field acoustic signal will be proportional to the time derivative of the volumetric fluid flow; that is, the fluid volumetric acceleration. Thus, a measurement of the fluid flow (displacement, velocity or acceleration) should provide a useful signal for use as either a feedback control signal or source signature signal for later processing steps.

A device equipped with a large revolving propeller would tend to act like a gyroscope. To mitigate these effects, in one embodiment it is possible to employ a plurality of source elements and connect them to a common frame. The propellers could be oriented so that their precession forces tend to cancel one another during towing, if a travel direction change is made. In another application, the frame could carry devices that have propellers whose pitch is reversed so that some propellers are designed to increase flow while being turned faster in a clockwise direction, while others have propellers designed to increase flow while being turned faster in a counter-clockwise direction. For this case, the source elements might be paired on a common frame to cancel the gyroscope effect. Other reasons for pairing units would be to help counteract reactive force created by outlet flow.

Another way to balance reactive forces created by a single monopole source element, like the one illustrated in FIG. 7, would be to modify its outlet region. For example, in one application, it is possible to replace the axial outlet scheme shown in FIG. 7 with one that is blocked axially, but has ports arranged circumferentially around exit area 739. In other words, the outlet flow would be directed radially instead of axially, thereby tending to balance forces associated with outlet flow.

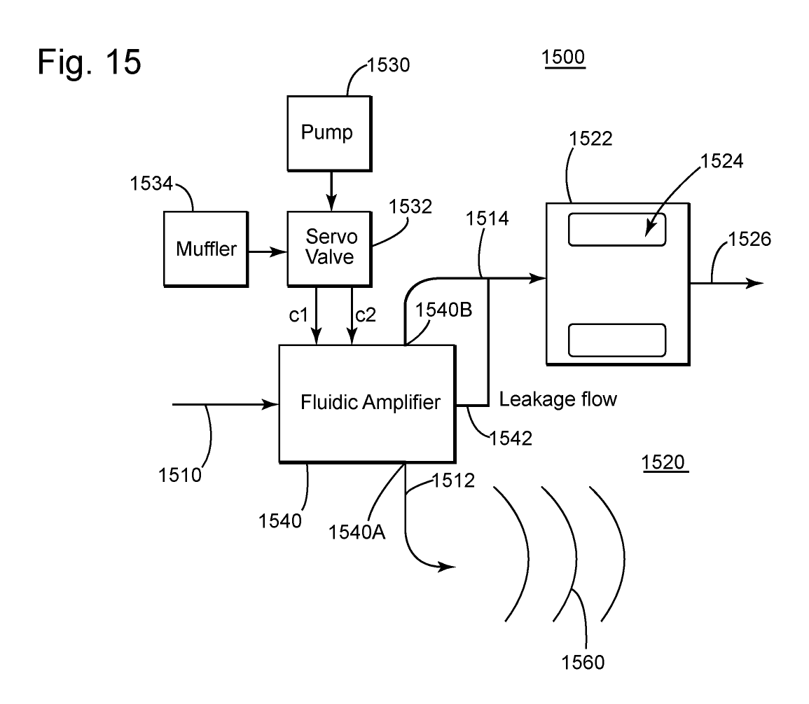

Other means may also be used to modulate fluid flow, for example, based on fluidics. In a fluidic amplifier, a small flow is used to control a larger flow, as disclosed, for example, in U.S. Pat. No. 4,000,757 (the entire content of which is included herein by reference), which illustrates a bistable fluidic amplifier. For one of the embodiments discussed above, it is possible to direct, as illustrated in FIG. 15, a large main input flow 1510 by two smaller control flows c1 and c2 so that it follows one of two different paths 1512 or 1514. The first exit path 1512 is in direct communication with the surrounding acoustic media 1520, while the second exit path 1514 dumps into a chamber 1522 equipped with one or more gas bladders 1524 that will tend to muffle the dynamic variations in the fluid flow, and then this low pass filtered fluid flow 1526 may exit into the surrounding media 1520. The inlet fluid flow 1510 for this source element 1500 could be generated by a pump, propeller or from an inlet ram like source element 400. The supply for the control flow could be provided by a small pump 1530 or from a ram inlet like that shown before, and a variable orifice 1532 (e.g., servovalve) could be used to switch or control the two control flows c1 and c2 used to direct the main flow 1510. A muffler 1534 may be connected to servovalve 1532 to damp any fluid oscillation that may be generated by pump 1530. FIG. 15 shows the interconnection of the fluidic amplifier 1540 to the servovalve 1532 that directs control flows c1 and c2, which cause the main flow 1510 to be directed either to one of two outlet ports 1540A-B. One outlet port 1540A is in direct communication with the surrounding water 1520 and creates an acoustic signal 1560.

The second outlet port 1540B as well as the leakage 1542 are connected to chamber 1522, which contains the compliant chamber 1524. Compliant chamber 1524 is configured to damp any fluid pulsations so that the water released is basically a steady flow of water. Outlet ports modulated flows 1512 and 1514 may be about 180 degrees out of phase if intended to generate a sinusoidal output. Thus, there is a need to have chamber 1522, which acts as a muffle, to achieve a net acoustic output.

In one embodiment, it is possible to use both outlet flows 1512 and 1514 instead of just one for acoustic output. For this embodiment, if a resonant chamber is added to phase shift one of the outlet flows so that at least, over a narrow band of frequencies, the resultant two modulated flows are additive (as long as the relative phase of the two flows are less than 90 degrees apart when combined) it should be possible to obtain a larger resultant amplitude.

Returning to the active and passive sources discussed above, a few observations about the compliant chamber are now discussed. The compliant chamber serves several useful purposes. First, because it is elastic, it allows the reservoir of liquid between the flow modulation device (propeller, sliding gate, variable orifice, etc.) and the elastic trapped gas volume to source or sink fluid flow transients created by the fluid flow modulator. Second, it can be used to create a resonance to improve the source element's overall efficiency. Third, for the active case, the compliant chamber is housed within a rigid outer shell, so the pressure fluctuations internal to the source element are acoustically isolated from the surrounding medium, thereby enabling the source element to act like an acoustic monopole. For the active case, the compliant chamber in combination with the internal fluid mass tend to stabilize, dampen and/or mitigate pressure fluctuations near the inlet due to pressure perturbations created by the action of the fluid modulation device, so that the acoustic energy radiated at the inlet is much less than the acoustic energy radiated near the outlet.

In the various embodiments previously described, a moveable barrier is used to prevent mixing between the fluid and gas volumes. A moveable barrier is needed particularly if the orientation of the source gas volume with respect to the gravity vector is unfavorable, variable, or if the source element undergoes vibrations which will tend to promote mixing of gas and fluid. The moveable barrier in the various embodiments described above can be a sliding piston, membrane, bladder, corrugated membrane, diaphragm, bellows or other suitable means. In practice, this moveable barrier will have some mass, may introduce some friction effect, or introduce some added stiffness effect. However, for the purposes of discussion, these effects will be assumed to be negligible.

The effective gas spring of the compliant chamber in combination with the total mass load create a second order resonant system. For example, using the embodiment shown in FIG. 8, the total effective driven mass (Me) will be composed primarily of two terms: 1) the radiation mass, which will be a function of the outlet diameter or area A₀, and 2) the mass of the liquid that lies between outlet region 839 and the walls of bladders 825. The resonant frequency (Fr) in hertz of this second order system is given by equation (3):

$${F}_{r} = \frac{{( \frac{{K}_{e}}{{M}_{e}} )}^{\frac{1}{2}}}{2 π} . \qquad ( 3 )$$

Assuming that the water is not compressible, that the compliant chamber gas behaves like an ideal gas, and that the gas chamber volume is large compared to the peak flow volume, the effective spring rate Ke in Newtons/meter of the source is given by:

$${K}_{e} = γ \frac{{A}_{0}^{2} {P}_{g}}{{V}_{g}} , \qquad ( 4 )$$

where A₀ is the outlet area; Pg is the gas absolute pressure (measured in Pa) at the operating depth; and Vg is the total gas volume at operating depth (measured in m³). The term is the polytropic index. If the expansion and contraction of the gas is an isothermal process then, γ=1. If the process is adiabatic (i.e., no energy loss) and the gas is diatomic, then γ=1.4. In practice, the process will neither be isothermal nor adiabatic, but somewhere in between. For this example, it can be assumed that γ=1.2.

In a typical low-frequency source design, it is desirable for the source element to have a resonance that falls within its intended operational frequency range. Thus, for a low-frequency source element designed to cover the range of low frequencies of 1 to 3 Hz, operating at a depth of 50 m, and having an outlet diameter of about 2 m (A₀=3.14 m²), it can be assumed the resonant frequency Fr to be about 1.4 Hz. Assuming that peak fluid displacement will be about 0.5 m³, the radiation mass corresponding to an acoustic piston (the effective trapped fluid mass being accelerated back and forth near the outlet will act like a piston of the same area) will be about 2,300 kg, and if the volume of the liquid inside the enclosure is assumed to be about 6.9 m³, there will be another 6,900 kg of mass. When this mass is combined with the radiation mass, it would result in Me=9,200 kg. Substituting this value in equation (3) results in a spring rate of about Ke=7.1×10⁵ N/m. At a depth of 50 m, Pg is about 9×10⁵ Pa. Equation (4) then requires that the gas volume needs to be about Vg=10 m³. If the peak flow volume is about 0.5 m³, the gas volume and the liquid volume are sufficient.

A ring-shaped bladder with a rectangular shaped cross-section having the following dimensions will be suitable: outer diameter of 2.6 m, inner diameter of 1.6 m and axial length of 3 m. These calculations have been presented for purposes of exemplifying one possible implementation of one of the embodiments and for giving the reader a sense of the dimensions, pressures and forces involved with such a low-frequency source element. The assumption of an ideal diatomic gas was used to simplify the calculations. If a monatomic gas were used, such as argon, then the polytropic index should be adjusted. The calculations assume a gas compression and relaxation process that lie somewhere between isothermal and adiabatic. Thermal analysis/simulations could be performed to better estimate the behavior of the gas under compression cycling. In addition, total liquid mass inside the enclosure will generally be larger than the effective mass. For example, not all of the liquid will be accelerated by the action of the fluid modulator due to stagnant areas within the enclosure volume, such as near corners or other flow restrictions. Fluid flow analysis/simulations could be used to estimate more accurately the effective fluid mass for a candidate source element design. The viscous damping effect of the liquid as it flows over surfaces around corners in the interior of the enclosure will also tend to dampen the resonance peak near Fr.

As can be observed from the above discussion, equations (3) and (4) are coupled, which is to say that for a selected resonant frequency, the selection of an effective mass impacts the required gas volume and vice versa. As a practical matter, if the coupled mass is reduced, the gas volumes become even larger. Thus, it is possible to end up with an even larger source element to deploy and tow. In addition, various limits may be imposed by the flow modulator driver or other devices that may constrain performance over some frequency interval within the desired operating frequency range. For example, the amount of torque and/or force that can be delivered by the flow modulator driver mechanism is finite. As the frequency increases, the amount of current and/or voltage required to operate the flow modulator, in general, increases above the resonant frequency. Also, as the amount of effective liquid mass that has to be accelerated back and forth increases, this will compound the problem and tend to load down further the flow modulator.

Therefore, in an embodiment, various calculations to optimize overall performance subject to certain factors are made. For example, these factors may include operating frequency range, resonant frequency, logistical concerns, deployment concerns, towing concerns, equipment constraints or other constraints. More specifically, in one embodiment it is anticipated that a calculation can be made to select/balance the sizes of the liquid coupled mass and/or gas volume so that overall performance (signal output, efficiency, overall size, tow force, etc.) is optimized subject to these constraints. Furthermore, it is recognized that the dimensions of the source, for example, acoustic opening size, length of the device, weight of the device (in and/or out of the water), can all be used as key variables in this selection process.

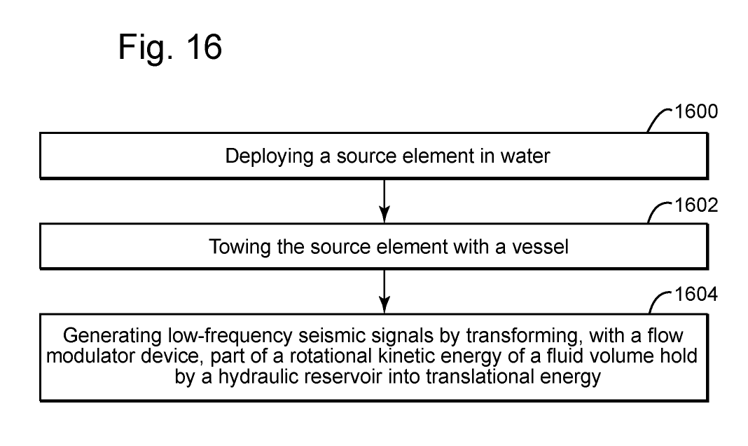

According to an embodiment, a method for generating low-frequency seismic signals is now discussed with regard to FIG. 16. The method includes a step 1600 of deploying a source element in water, a step 1602 of towing the source element with a vessel, and a step 1604 of generating low-frequency seismic signals by transforming, with a flow modulator device 1308, part of a rotational kinetic energy of a fluid volume held by a hydraulic reservoir 1302 into translational energy. The method may further include a step of imparting rotational kinetic energy to the fluid volume with a rotational kinetic energy actuator 1306, and/or a step of compressing and decompressing a given gas volume housed by a compliant chamber 1304 when the part of the rotational kinetic energy of the fluid volume is transformed into translational energy. It is also anticipated that in another embodiment, a passive source element could be stationary, suspended from a platform, float or buoy rather than being towed. A stationary source may be of value for reservoir monitoring applications that employ 4-D survey techniques in which surveys are repeated and compared to estimate changes to reservoir fluid locations/volumes. For the marine case, a stationary source along with nodes or ocean bottom cable may be of use for 4-D surveys.

The above embodiments were discussed without specifying the type of seismic receivers used to record seismic data. In this sense, it is known in the art to use, for a marine seismic survey, streamers towed by one or more vessels, and the streamers include seismic receivers. The streamers may be horizontal, slanted or have a curved profile as disclosed, for example, in U.S. Pat. Nos. 8,456,951 and 8,451,682, the entire contents of which are incorporated herein by reference.

Also, the above embodiments were discussed in a marine environment in which a depth of the ocean bottom is at least 100 m relative to the water surface. For depths less than 100 m, which is called a transition zone area, the above sources may be modified as now discussed to address the shallow water conditions. Note that transition zone areas may include estuaries, lagoons, shoreline, tidal zone, marsh or wetlands, etc. Some of the transition zone sources to be discussed next, are more appropriate for even smaller depths, e.g., less than 3 m because they have small sizes, around 0.5 to 3 m.

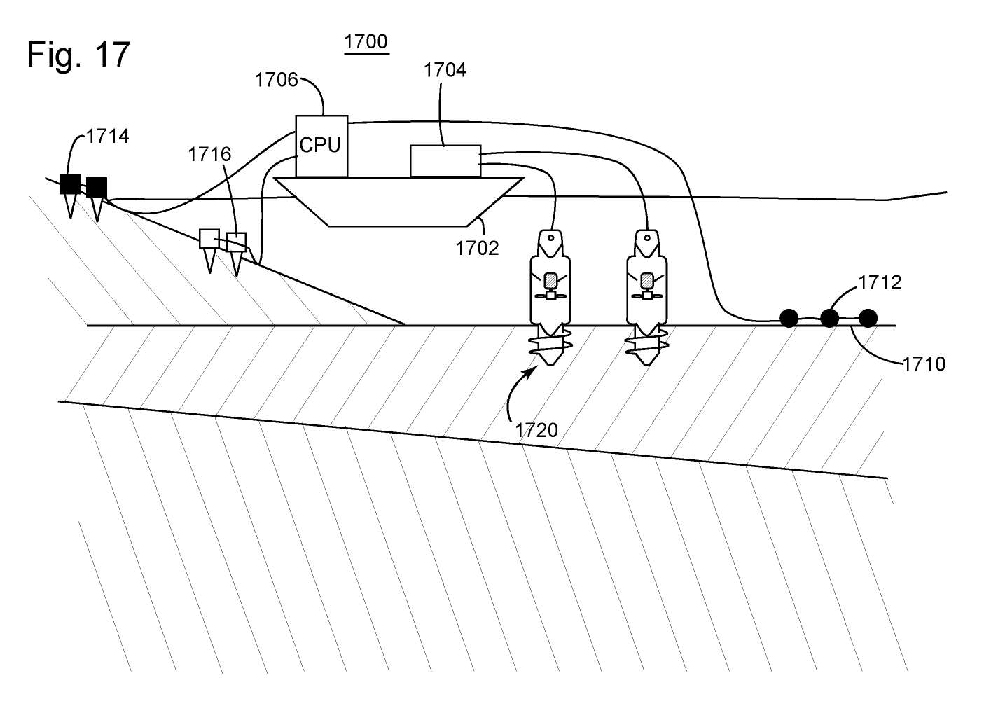

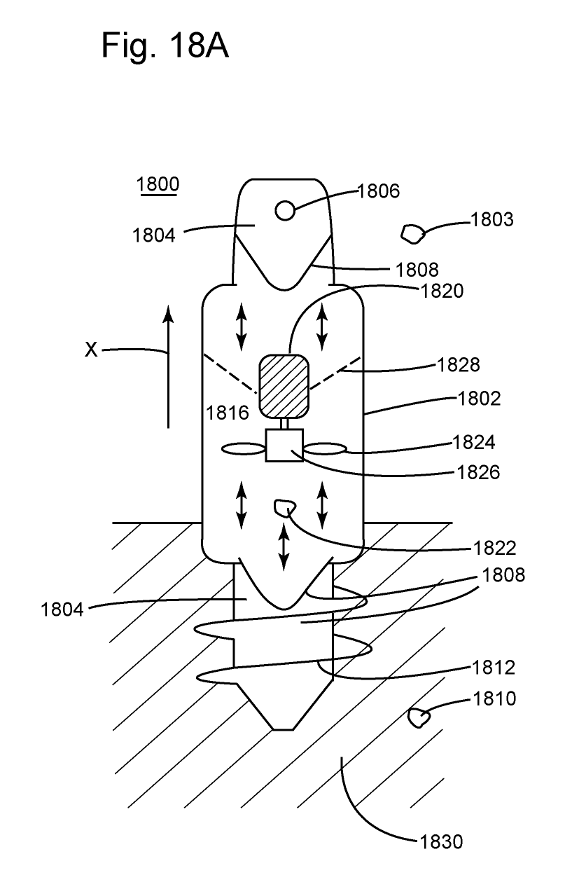

FIG. 17 shows a transition zone area acquisition system 1700 that uses a vessel 1702 (it can be any floating platform, e.g., a barge, small boat, etc.) that provides computing and control units 1704 and 1706 to various seismic receivers and sources. Control unit 1706 is connected to seismic receivers 1712 that are located on the ocean bottom 1710. This seismic arrangement is known in the art as ocean bottom cable (OBC). Seismic receivers 1712 may be hydrophones, geophones, accelerometers, etc. Simultaneously, control unit 1706 may be connected to other seismic receivers 1714 and 1716, where receivers 1714 are land receivers (i.e., not designed to be used underwater) while receivers 1716 are distributed so close to the shoreline that a conventional streamer vessel cannot reach them. Receivers 1714 and 1716 may have the same compositions as receivers 1712.

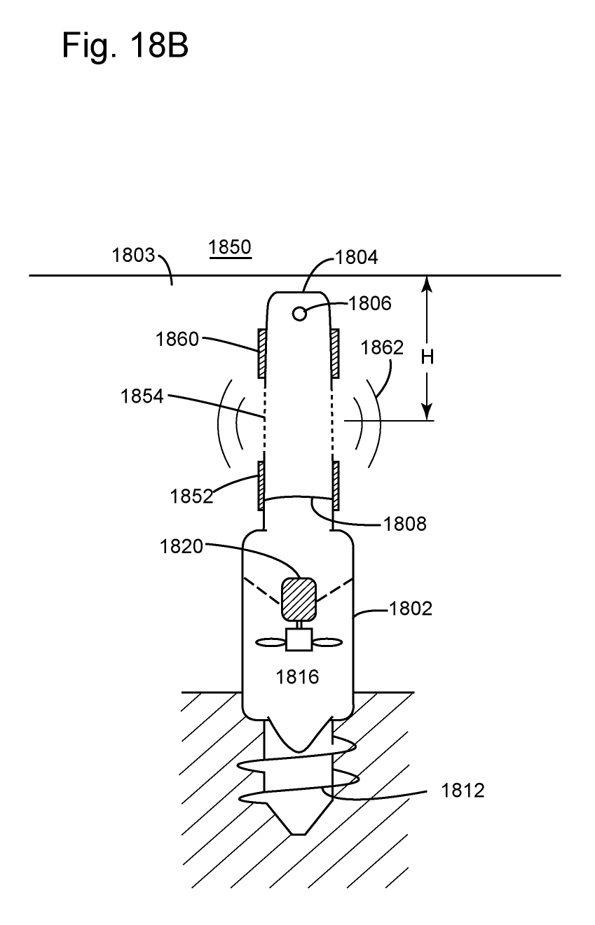

One or more transition zone sources 1720 may be attached to the ocean floor 1710, as illustrated in FIG. 17. In one embodiment, transition zone sources 1720 are screwed in the ocean floor. Other methods may be used to attach the transition zone source to the ocean bottom. FIG. 18A shows an embodiment in which a transition zone source 1800 is attached to the ocean bottom 1810 with an auger base 1812. Transition zone source 1800 has a housing 1802 that includes one or more compliant chambers 1804 that accommodates a gas volume 1806. Housing 1802 is surrounded by ambient water 1803. FIG. 18A shows two compliant chambers 1804, one at the top and one at the bottom of the housing. A flexible barrier 1808 separates gas volume 1806 from an interior passage 1816 of transition zone source 1800.

An actuation device 1820 is located inside passage 1816 and configured to translate a fluid mass 1822 up and down along a longitudinal axis X of the housing. Actuation device 1820 may be a motor having one or more blades 1824 attached to a hub 1826. Hub 1826 may be configured to change an orientation (pitch) of the propeller's blades 1824 to control the fluid flow. Actuation device may be attached with a bracket 1828 to an interior of housing 1802. By changing the orientation of the blades or the rotation direction of the motor, the fluid volume 1822 is moved up and down along axis X. Thus, the fluid acts as a reaction mass that imparts a force to the housing. Because the housing is coupled to the ocean bottom via the auger base 1812, sound waves 1830 may be generated into the water and/or directly into the ocean bottom. Note that in this case, the fluid volume 1822 inside passage 1816 does not communicate with the ambient of the source.

According to a variation of this embodiment, FIG. 18B shows a transition zone source 1850 that has one compliant chamber 1804 at the top of the source. An adjustable open port 1852 that communicates with the ambient water 1803 may be provide to act as the compliant chamber 1804. Thus, this compliant chamber is full with ambient water. A net or other open and flexible material 1854 may be placed over the port for preventing debris or other contaminants to enter the housing. A threaded collar 1860 may be provided partially over the compliant chamber and the port 1852 for adjusting an opening of the port and its depth H relative to the water surface. In this way, the collar may be moved up and down to adjust the liquid mass loading, vary the dipole length, adjust/compensate for water depth and frequency range. As a downward force is applied to the seabed 1812, a positive pressure is created in the fluid near the port 1852. Note that the fluid inside passage 1816 is prevented by barrier 1808 from communicating with water 1806. Thus, a sound wave 1862 is generated, which may be part cancelled by the surface reflection ghost.

According to another embodiment, a flow modulated seismic source as discussed above may be adapted to be used in a borehole. Borehole sources are commonly used in conducting reverse vertical seismic profiles. These surveys are useful in determining the acoustic properties of the geological formation surrounding a borehole. Typically, a small source that is attached to a wireline cable is lowered into a borehole that is often fluid filled. The source is usually raised and/or lowered to a number of different depths and activated with a shot record collected at each level. A receiver spread that typically uses geophones is located at the surface. When the source is activated, the seismic signal propagates from the source through the borehole walls and into the surrounding geologic formation and a portion of the radiated energy propagates through the strata to the surface where the seismic signal is measured.

Because each stratum typically has different acoustic properties, the seismic signal ray path is altered (reflected or refracted) as it propagates through the rock layers and impinges on interfaces. This changes the arrival time of the signals. When the source is moved, its radiated energy travels a different path to the receivers to provide additional information. In addition to imaging information, the acquired data set can provide information that is useful for tying conventional seismic surveys to well logs that can be used in reservoir modeling. Borehole sources can be impulsive, for example airguns, or vibratory, for example piezoelectric bender types or even small hydraulic vibrators that couple directly to the casing. There is always a concern about the use of impulsive sources in boreholes, because they release all of their output at once. This creates large peak stresses in the borehole that can lead to casing cement failures.

Vibratory sources do not produce much low-frequency energy (energy below 10 Hz) due to stroke limitations—this is especially true if the energy is coupled via the borehole fluid. Hence there is a need for a fluid-coupled borehole vibratory source capable of producing low to moderate seismic frequency signals.

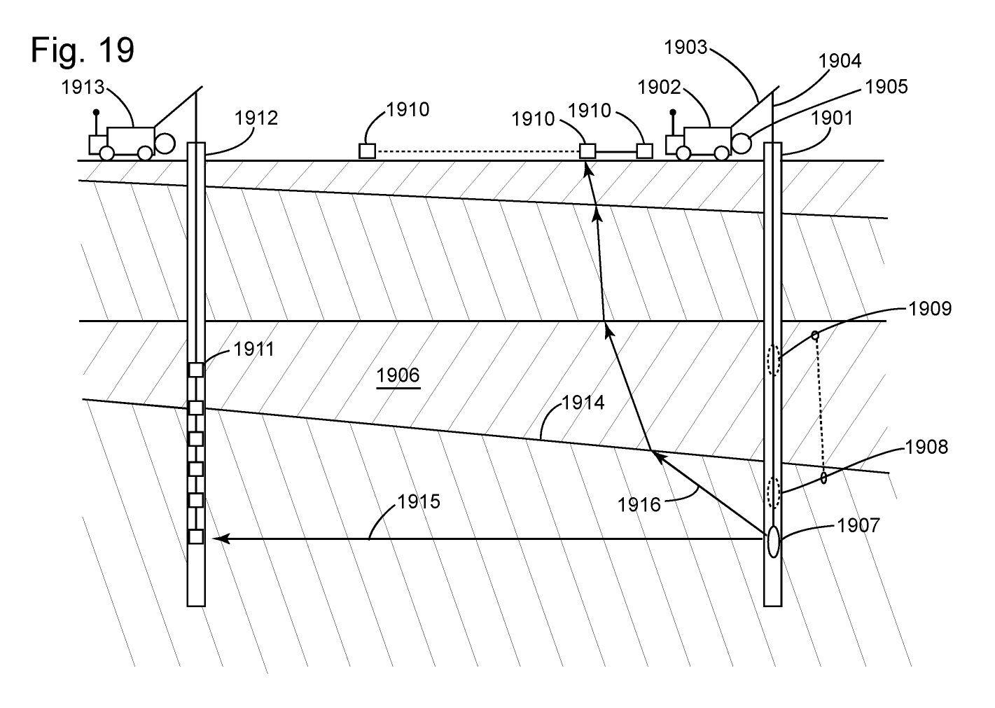

According to an embodiment illustrated in FIG. 19, there are two possible methods for using a borehole source to determine properties of rock formations at or near a borehole. Various layers of earth strata 1906 are shown in the figure with the equipment arranged near well 1901 to perform a reverse VSP. On the left is a second well 1912, which is equipped with downhole receivers 1911. Downhole receivers 1911 are deployed at different levels and they can be used in conjunction with source 1907 deployed in borehole 1901 to perform cross-hole tomography survey, useful for determining properties of rock strata between the two wells.

Borehole 1901 is assumed to be fluid filled at least for depths that lie below the water table. Source 1907 is a flow modulated source to be described later, that is connected to a wireline cable 1904 that is suspended from a boom 1903 and connected to a wench mechanism 1905 located on or near service truck 1902. Service truck 1902 may contain equipment to both control/operate source 1907 and to control its operating depth. In addition, geophones or other receivers 1910 are arranged at the earth's surface, near borehole 1901. Source 1907 typically is lowered to a starting depth and emits a seismic signal over a pre-determined frequency band. Some of the radiated seismic signals travel as a P-wave and follows ray path 1916 when traveling from source 1907 to receiver 1910 where they are recorded. The seismic signal travels like a wave through the rock layers with part of its energy refracted at a layer interface where the two layers may have different acoustic impedance, for example, interface 1914, and passing on through the adjacent layer and being refracted and transmitted until a portion of the signal is recorded by receiver 1910. Also, at each interface, it is possible that some energy may be reflected or undergoes mode conversion, for example going from P-wave to S-wave. The travel time for the seismic signal to traverse ray path 1916 is dependent upon the velocity in the various rock layers and the distance in each rock layer. Snell's law determines the seismic wave front refraction angle for each interface. Other effects can occur at interfaces, as mode conversion from pressure to shear waves, and reflected signals are possible.

The process is repeated at various source depths, usually at regular intervals between endpoint levels 1908-1909. Signals to operate and monitor source 1907 are carried in wireline cable 1904 where they connect to a source control and acquisition management system located at or near vehicle 1902. Remote operation is possible via telemetry links, for example, via a radio link to a remote site. The received signals are also recorded using a data acquisition system that is also interfaced to the acquisition management system located at or near service truck 1902 or it could be linked to some remote site using wireless transmission means.

The acquired data set can be processed to either image the rock formations near the well or to determine the velocity of sound through the various rock formations at seismic frequencies, which typically are much lower in frequency than are utilized in a sonic log that utilizes ultrasonic signals. Velocity measurements of the rock layers made using a reverse vertical seismic profile are useful in forming well ties to reconcile conventional seismic data with well logs.

Simultaneously or at a different time, a cross-hole tomography survey could be conducted with source 1907 operated as stated above at various levels. At the same time, a portion of the seismic energy produced by source 1907 propagates horizontally, through the rock formation, to borehole 1912, which is equipped with receivers (geophones, accelerometers or hydrophones) at different levels. For example, some energy follows ray path 1915. The received signals travel through wireline cable and are recorded using equipment located in service truck 1913, which is also equipped with a boom and wench useful for raising and lowering the receiver string. Data acquired through cross-hole tomography can be used to measure the transit time and/or amplitude of P- and/or S-waves from a source in one borehole to geophones in another borehole, which is useful for determining the velocity of seismic signals in the various rock layers. The amplitude information can be used to measure acoustic absorption in the various rock layers.

A flow-modulated source 1907 for use in the borehole can be of two types. The first type is called active and the second type passive and they can be used to perform either reverse vertical seismic surveys or cross-hole tomography surveys using one of the methods described above. A passive source employs a propeller or vane to create a fluid flow. The vane, propeller or impeller act on the liquid to create the flow disturbance. An active source is a source that relies on its own linear motion to create a net static flow, which is modulated by an orifice or other device to create pressure disturbances. The linear motion of the source in the borehole can be induced by the action of gravity, by a force applied through a wireline cable, or in some cases, the source may be pulled and/or pushed by a special borehole tractor to be described later. Both active and passive sources share three common features: 1) a compliant chamber which may be gas-filled; 2) means to generate a fluid flow; and 3) means to modulate the flow rate.

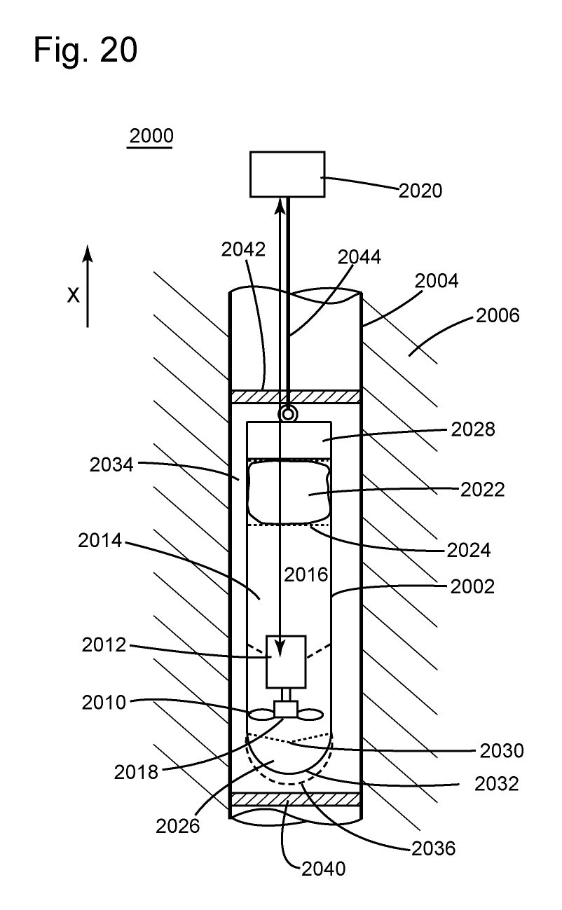

According to an embodiment illustrated in FIG. 20, a passive borehole source 2000 has a housing 2002 that is lowered into a casing 2004. Housing 2002 accommodates a propeller 2010 that is driven by a motor 2012. Those skilled in the art would understand that other actuation means may be used for moving up and down the fluid volume 2014. Fluid volume 2014 is contained inside passage 2016. The blades of propeller 2010 are attached to a hub 2018, which is configured to change an orientation of the blades so that a movement direction of the fluid volume can be reversed. Alternatively, a source controller 2020 may instruct the motor to rotate in the opposite direction. Housing 2002 may be a hollow cylinder that is closed at one end (the top end) and open at the other end (when boot 2032 is not present, as discussed later).

The interior of housing 2002 also includes a compliant compartment 2022 (e.g., gas-filled bladder, diaphragm, or bellows) that can freely expand or contract as the fluid pressure inside the housing changes. The gas-filled compliant compartment may be connected to the surface through a hose (not shown; or it may be connected to a gas pressure regulator system, also not shown) so that the compartment's volume can be adjusted to compensate for operating depth or in other ways described later.

A screen 2024 may be used to keep the compliant compartment from expanding too much if there is a rapid pressure drop due to a change in operating level. When the passive borehole source is at the desired depth level, the motor 2012 is commanded by the source controller 2020 to activate propeller 2010. Propeller 2010 acts like a pump to generate a volumetric flow that is related to its rpm, direction and blade pitch. The propeller hub 2018 may contain devices to vary the propeller's pitch and/or reverse pitch. In other words, in one embodiment, the propeller is controlled either by changing its pitch or the motor is reversed to generate fluid flows in upward and downward directions along axis X. The propeller's speed, direction and pitch are controlled by the source controller to produce a seismic signal having a desired frequency spectrum and/or follow a target signal.

Passive borehole source 2000 acts like a monopole acoustic source. As the propeller generates an outward flow of fluid (i.e., along the negative direction of direction X), the fluid is removed from the interior of the housing and the compliant chamber expands. Because the housing is rigid and closed at one end, the drop in pressure in the interior of the housing is not in communication with the surrounding medium, and thus, a net pressure increase is produced near the outlet 2026 of the housing. Similarly, when the propeller directs the fluid flow inward (i.e., along the positive direction of the X axis), the internal chamber pressure rises, causing the compliant compartment to collapse. The rise in internal pressure inside the housing is isolated from the medium.

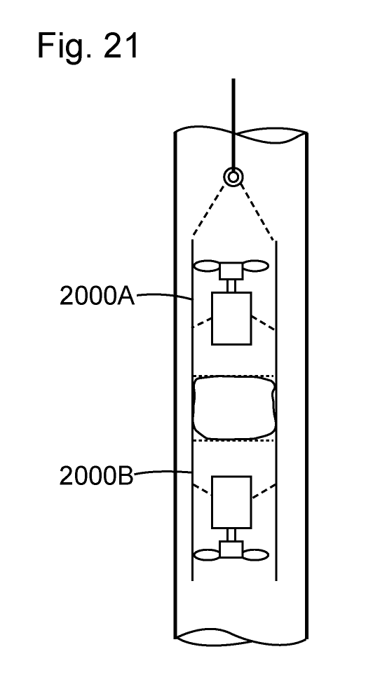

In one application, a reaction mass 2028 may be attached to the passive borehole source 2000 to reduce any axial vibration of the source. In another embodiment, two passive borehole sources 2000A and 2000B may be connected back to back, as shown in FIG. 21, so that their reaction forces are cancelled and the tendency to move axially is mitigated.

Returning to FIG. 20, an internal guard or screen 2030 can be used to protect the outlet and propeller from debris that may be inside the borehole. In one application, an outside guard or screen 2036 may be used for the same purpose. In still another application, both guards may be used. A rubber boot, diaphragm or bellows 2032, could also be used to isolate the working fluid 2014 inside the housing from the borehole fluids 2034. Note that for the embodiment discussed above, boot 2032 is not present. Boot 2032 allows the transfer of acoustic energy between the source and the surrounding borehole fluids, but also provides a barrier against the mixing of internal fluid and the borehole fluids. This would also allow the internal working fluid to be oil or distilled water, for example, which may extend the life of the motor bearings and prevent corrosion.

In fluid filled boreholes, tube waves can sometimes create problems. Tube waves are acoustic waves that propagate up and down in the column of borehole fluid 2034 and usually occur at about 3 Hz. To mitigate this problem, packers that help prevent the propagation of tube waves can be used to isolate a portion of the borehole. For example, the passive borehole source 2000 could be equipped with packers, one packer 2040 being located at some distance below the source and another packer 2042 located somewhere above it, to provide a trapped fluid volume in which the source can operate, as illustrated in FIG. 20. The packers could be integrated into the system and move as the source is moved, together with cable 2044, which is connected to the source. Alternatively, the packers could be fixed in place and the source used at only the depth levels between the two packers. The above discussed passive borehole source 2000 can be adapted to work in horizontal wells.

As noted above, FIG. 21 shows two sources 2000A and 2000A (similar to source 2000 of FIG. 20) that are arranged back to back to form a twin driver configuration to balance out any vertical reaction forces. In the twin driver configuration of FIG. 21, the two liquid filled compliant compartments are connected together to form a common compliant chamber. In either twin driver arrangement, the propeller pitch, direction and rates of rotation could be synchronized so that the fluid flow rates exiting or entering the top or bottom of the source are about the same at any point in time, thereby reducing any tendency to vibrate axially. As before, the twin driver could be utilized in a borehole section that is isolated by the use of packers. If the flows are synchronized and the distance separating the two flow outlets is small compared to a wavelength, then the source will act as a monopole.

In one embodiment, a number of passive borehole sources 2000 like the one in FIG. 20 and/or those in FIG. 21 could be arranged to form a string of sources to form a vertical array in a vertical borehole. By knowing the speed of sound in the borehole fluid and the range of seismic frequencies to be emitted, the source array element spacing can be set. In one application, the amplitude, phasing or timing (delay) of the signals used to drive the individual sources could be optionally adjusted to direct the combined output energy (seismic waves) in a preferred direction(s) that may be helpful for use in cross-hole tomography or reverse vertical seismic profiling to better illuminate a target of interest.

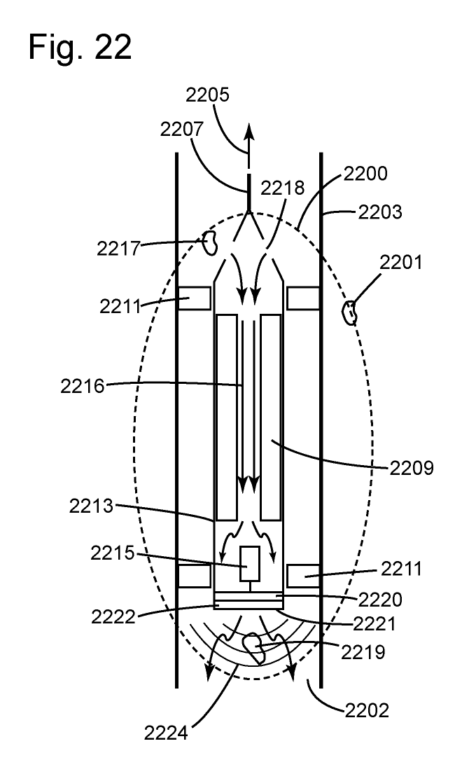

According to another embodiment, a passive borehole source is now discussed with regard to FIG. 22. Passive borehole source 2200 is deployed within a borehole 2202 that is filled with liquid 2217. A pipe casing 2203 is located inside borehole 2202 and cemented to rock formation 2201. Passive borehole source 2200 has a housing 2213 that can be cylindrical in shape and made of a metal or other material well suited for use in fluid filled boreholes. Housing 2213 is configured to accommodate one or more compliant chambers 2209. The compliant chamber can be an elongated ring gas-filled bladder.

Housing 2213 also accommodates an actuating device 2215, e.g., servomotor, which may be attached to the housing with a bracket (not shown). Actuating device 2215 drives moving plate 2220, e.g., rotates it. Moving plate 2220 works in conjunction with a fixed orifice plate 2222 that is attached to housing 2213 to form a variable orifice mechanism. The variable orifice mechanism acts as the flow modulator for the passive borehole source 2200.

Optionally, one or more dynamic seals 2211, for example a lip, bushing or a segmented roller seal, or other seal compatible with the borehole environment that can at least partially or substantially block the axial flow of liquid past it while source 2201 is moving, are attached to housing 2213 and slide, glide or roll against the casing 2203. Seal 2211 forces the ambient fluid 2217 to enter through ports 2218 inside housing 2213 as source 2201 is pulled up by force 2205 through the borehole via cable 2207, which is attached to housing 2213. In one application, seal 2211 may contain a mechanism (e.g., a pump that inflates the seal) to radially activate or retract it; when activated, the seal contacts casing 2203 and when retracted, seal 2211 does not substantially contact casing 2203.

In an embodiment, source 2200 is lowered to a certain depth via cable 2207 with the seal 2211 retracted. Once at the desired depth, seal 2211 is activated to press against casing 2203. Then, upon receiving a command from the data acquisition management system, force 2205 is applied to cable 2207 and source 2200 is pulled toward the surface at a rate of, for example, about 1 m/s. Other speeds are possible. In one application, consider that the source is pulled for 30 s.

In the 30 s interval, source 2200 will travel about 30 m. While source 2200 is moving, fluid 2217 enters inside housing 2213 through ports 2218 and moves through the source to exit as volume 2219 at the source's outlet 2221. The movement of the fluid 2217 through the source is illustrated by arrows 2216. At the same time, actuating device 2215 moves plate 2220, for example rotates it, (could be a sliding plate instead of rotating), at a variable but controlled rate. The speed that moving plate 2220 moves with respect to orifice plate 2222 will determine the frequency imparted to the borehole fluid 2217 that moves through the source and consequently into the surrounding rock formation.

Actuating device's speed can be varied as a function of time to generate a swept sine wave emission signal. Other signal types are possible. For example, the rpm of actuating device 2215 could change so that at the start of the sweep a frequency of 3 Hz is emitted with the rpm increasing monotonically at a rate chosen so that at, for example, 30 s, the rpm is sufficient to produce a 100 Hz signal. The rate of change in rpm could be linear or nonlinear. In another embodiment, the actuating device's speed is varied in a pseudorandom fashion. Sensors (not shown), for example, a hydrophone, could be located in the fluid near the outlet region 2221 to measure the source output. The output signal 2224 can be sent to a recording system at the surface via cable 2207. The hydrophone signal could be sent as an analog signal, or digitized and then sent back to the surface via cable 2207.

In another embodiment, source 2200 could be equipped with a weight, sufficient in size, to produce a gravity force that would cause source 2200 to descend while the seals are activated. In this case, source 2200 could be deployed at a starting depth. Tension 2205 in cable 2207 could be reduced and source 2200 would descend in the hole due to the gravity of the weight. For this case, the flow inlet would be through the orifice plate 2222 with the flow outlet at the top of the source. A pressure fluctuation would still be created in region 2219.

In this embodiment, if repeated sweeps are required over a particular borehole depth interval, some signals could be recorded with the source moving up through the depth interval and other signals could be recorded with the source moving down through the same or a different or overlapping depth interval.

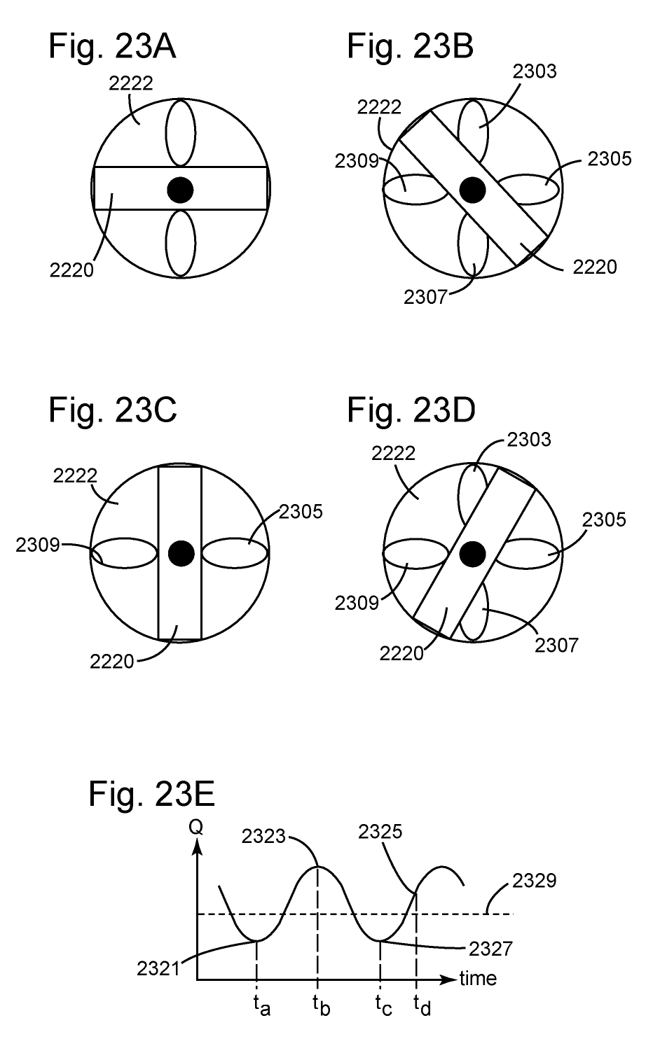

FIGS. 23A-D show various configurations for the flow modulator. Plate 2220 rotates in a clockwise fashion with respect to orifice plate 2222. Plate 2222 has four holes arranged at 90 degrees with respect to one another. More or less holes may be formed in plate 2222. As plate 2220 rotates, it covers some holes entirely, partially or not at all depending upon its angular position. When a hole is completely or partially covered, this creates a change in orifice area, which results in a flow metering effect. Thus, the total fluid flow rate through orifice plate 2222 at any point in time will be a function of the amount of total area open to flow at that instant. The graph shown in FIG. 23E shows the flow rate Q at various points in time. FIGS. 23A-D show the position of the moving plate 2220 at respective times ta, tb, tc, and td with resultant flows rates of 2321, 2323, 2327 and 2325. The resultant flow rate is shown to vary about an average flow rate 2329, since there is never complete blockage of all orifices at any point in time. It will also be appreciated that one revolution of plate 2220 in this embodiment can produce 2 cyclical changes in flow rate. In other words, the signal output frequency will be twice that of the rotating plate 2220 frequency. Other ratios are also possible. In one embodiment, rotating plate 2220 may also have holes.

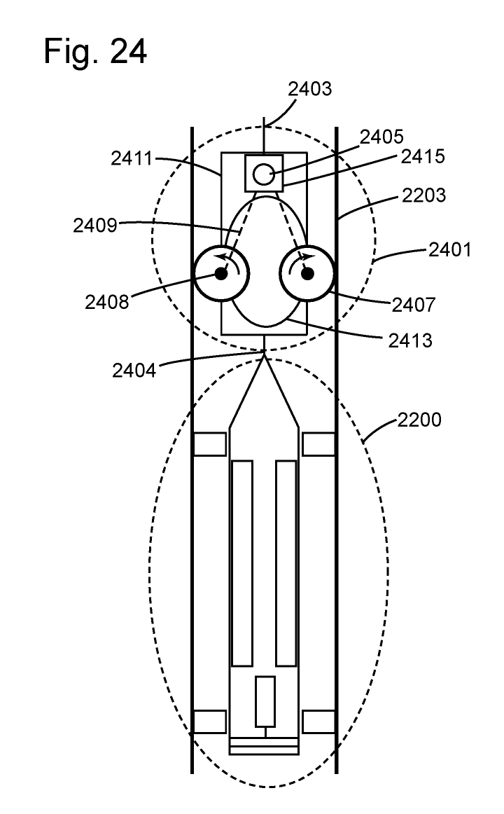

Source 2200 discussed with regard to FIG. 22 may also be used in conjunction with a tractor 2401 as now discussed with regard to FIG. 24. Tractor 2401 may be any device that provides pulling or pushing force in a borehole. Tractor 2401 can be used to pull or push source 2200 through the borehole. This may be helpful, for example, especially in horizontal wells. Tractor 2401 can be located above or below source 2200 and it can be connected via a flexible but rigid linkage or by a tension member, like a cable 2404, to source 2200. The tractor can be used to either assist a tow cable 2403 or used independently to move source 2200.

Tractor 2401 is shown in FIG. 24 having a housing 2411, on which two driving devices 2407, for example wheels, are mounted. Driving devices 2407 may be preloaded by a spring 2413 or other means to contact casing 2203. Drive mechanisms 2408 are linked to drive motor 2405, also located on housing 2411, via transmission device 2409, for example chain, belt or gear mechanism, so that power delivered by motor 2405 causes drive mechanisms 2408 to engage casing 2403 and create a linear force to move tractor 2401. Drive mechanisms 2408 may be retractable so that they do not engage casing 2203 when the tractor 2401 is not needed. Motor 2405 is connected to motor controller 2415 that is in communication with the data acquisition management system, which may be located at the surface, via cable 2403.

Most of the above discussed sources include a compliant compartment. The compliant compartment discussed in this disclosure serves several useful purposes. First, because it is elastic, it allows the reservoir of fluid between the flow modulation device (propeller, sliding gate, variable orifice, etc.) and the elastic trapped gas volume, to source or sink fluid flow transients created by the fluid flow modulator. Second, the compliant compartment can be used to create a resonance to improve the overall efficiency of the source. Third, for the active source, the compliant compartment is housed within a rigid outer shell, so the internal pressure fluctuations internal to the source are acoustically isolated from the surrounding medium, thereby enabling the source to act like an acoustic monopole. For the passive source, the compliant compartment in combination with the internal fluid mass tend to stabilize/dampen/or mitigate pressure fluctuations near the inlet, which are due to the pressure perturbations created by the action of the fluid modulation device, so that the acoustic energy radiated at the inlet is much less than the acoustic energy radiated near the outlet.

In the various embodiments previously described, a moveable barrier is used to prevent mixing between the fluid and gas volumes. A moveable barrier is needed in particular if the orientation of the source gas volume with respect to the gravity vector is unfavorable, variable or if the source undergoes vibrations which will tend to promote mixing of gas and fluid. The moveable barrier in the various embodiments described above can also be a sliding piston, membrane, bladder, corrugated membrane, diaphragm, bellows, or other suitable means. In practice, this moveable barrier will have some mass, may introduce some friction effect, or introduce some added stiffness effect. However, for purposes of this application these effects are assumed to be negligible.

A greatly simplified explanation of the resonance effect noted above is as follows. The gas volume in the compliant chamber in combination with the borehole effective liquid stiffness create a combined spring constant Kₑ, which in combination with the fluid mass load create a second order resonant system. For example, using the embodiment shown in FIG. 20, the total effective driven mass (Mₑ) would be comprised primarily of two terms: (1) an effective borehole liquid mass, which is a function of the outlet diameter or area Aₒ in combination with an axial length, and (2) the mass of the fluid that lies between the outlet and the walls of the bladder(s). The effective axial length will depend upon whether a section of the borehole is isolated using packers or not. In practice, a borehole would generally have various resonance modes. Some are axial and some are radial modes and/or combinations. The effective liquid bulk modulus, liquid density, borehole stiffness, dimensions of the source, dimensions of the borehole, location of packers if they are used, and other factors can influence separately or in combination the various resonance modes and the resulting resonant frequencies. Fluid filled borehole simulations in combination with experience may be used to help determine operating frequencies and source parameter settings, for example gas pressure and gas volume, to produce suitable source resonances for improved efficiency.

The resonant frequency (Fᵣ) in Hz of a second order spring-mass system is given by equation:

Fᵣ=(Kₑ/Mₑ)^{1/2}/(2π), (5)

where it is assumed that the compliant compartment gas behaves like an ideal gas, and that the gas chamber volume is large compared to the peak flow volume. Under these assumptions, the effective gas spring rate K_{g} of the source is given by:

K_{g}=γAₒ²P_{g}/V_{g}, and (6)

the combined spring constant Kₑ is given by:

Ke=1/[(1/K_{g})+(1/K_{b})] (7).

The terms in equations (5) to (7) are defined as follows: Aₒ is the outlet area; P_{g} is the gas absolute pressure (Pa) at the operating depth; and V_{g} is the total gas volume at operating depth (m³). The term y is the polytropic index of the gas. If the expansion and contraction of the gas is an isothermal process then γ=1. If the process is adiabatic (no energy loss) and the gas is diatomic, then γ=1.4. In practice, the process will neither be isothermal nor adiabatic, but somewhere in between. For this example it is assumed that γ=1.2.

Because the hydrostatic pressure can vary greatly with depth, (which is about 11 bar absolute pressure at 100 m depth and about 301 bar at 3000 m depth), if a single bladder with a fixed air mass will shrink in volume with depth, its pressure will increase with depth. At the same time, the volume of fluid inside the source may increase. This creates two issues: it changes the maximum amount of peak flow that can be achieved, and it may shift the source resonant frequency. For example, one result might be that K_{g} will increase by a factor of about 27 causing an increase in Kₑ. For this situation Mₑ will increase slightly, so the net result would be that Fᵣ would increase, which may be undesirable.

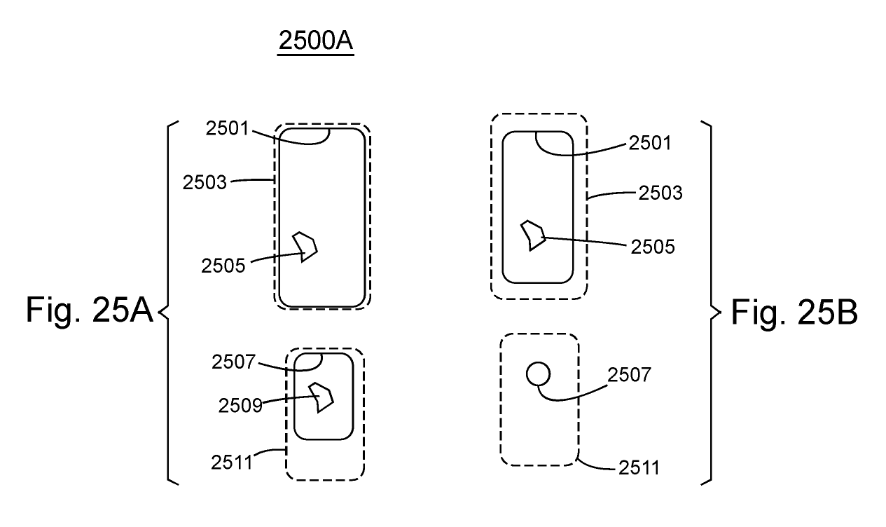

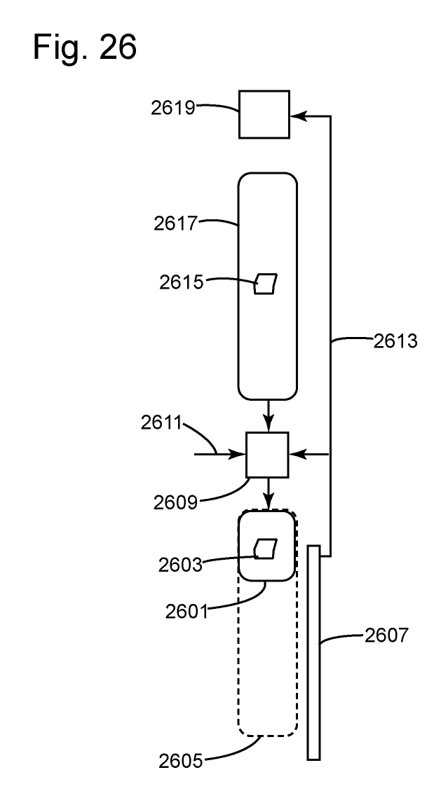

FIGS. 25A-B and 26 show two different embodiments to address this issue. The embodiment illustrated in FIGS. 25A-B uses a plurality of constrained gas compartments with at least one compartment active over a certain depth range. The second embodiment illustrated in FIG. 26 uses a metering mechanism to adjust the pressure and volume of the gas-filled compliant compartment.

FIG. 25A shows a compliant compartment 2500A that includes two separate gas compartments 2505 and 2509 contained respectively by moveable partitioning devices 2501 and 2507, which can be, for example, a rubber bladder or a membrane or sliding piston equipped with gas tight seals riding inside a sleeve. More than two separate gas compartments are possible. The gas used inside these compartments can be dry air or dry nitrogen, for example. Moveable partitioning devices 2501 and 2507 are each housed respectively within containment devices 2503 and 2511. Containment devices 2503 and 2511 can be, for example, a screen cage, or they could be a cylindrical sleeve housing a moving piston. Containment devices 2503 and 2511 act to limit the travel (or expansion) of moveable partition 2501, but still allow the moveable partition devices 2501 and 2507 to respond to the surrounding fluid pressure. The containment devices can be integrated within the partitioning devices, for example if moveable partition device 2501 was a rubber bladder, it could contain glass, Kevlar or other suitable reinforcement fiber that would limit the maximum possible volumetric expansion of the bladder.

In an embodiment, gas compartment 2505 is filled with pressurized gas suitable for operation at a certain depth, for example 200 bars (20 MPa) and gas compartment 2509 is filled with gas at 10 bars (1 MPa). Other charge pressures are possible. At the surface, not shown, both moveable partition devices 2501 and 2507 may stretch until they contact the walls of the containment device 2503 or 2511. Once the source is deployed, the hydrostatic pressure rises and FIG. 25A, for example, shows the position of containment devices 2503 and 2511 when the source is ready to be operated at modest depth, for example 150 m. At 150 m depth, moveable partition device 2507 is no longer constrained by containment device 2511, and its internal pressure will rise to match the hydrostatic pressure there, for example to about 15 bar. Since moveable partition devices 2507 at 150 m is no longer constrained by containment device 2511, it can freely respond to dynamic changes in the internal fluid pressure and acts as a compliant chamber with a certain volume “V₁”.

At the modest depth of 150 m, the hydrostatic pressure is still insufficient to cause moveable partition device 2501 to change its volume and the moveable partition device is still constrained by containment device 2503. Thus, gas compartment 2505 does not respond to dynamic pressure fluctuations in the fluid in its vicinity. At about 150 m, the compliant chamber will have a pressure of about P_{g}=1.5 MPa and a volume V_{g}=V₁.

FIG. 25B shows the same compliant chamber as before, only the device is now at a depth of, for example 2,500 m. At this depth, the hydrostatic pressure value will be about 25 bars (25 MPa). At this high ambient pressure, moveable partition device 2507 will have collapsed to a very small volume and becomes effectively inactive. At the same time, the high surrounding pressure is sufficient to cause moveable partition device 2501 to shrink enough to lose contact with containment device 2503 and thus, it is free to act as a compliant chamber having a volume of V₂. This means that at about 2,500 m, the compliant compartment would have a pressure of about P_{g}=25 MPa and a volume of about V_{g}=V₂.

It will be appreciated that by selecting the proper size gas compartments, number of separate gas compartments, charge pressures, and volumetric constraints, an effective compliance constant Kₑ can be maintained to within a certain range of values over a wide operating depth range. This will allow the operator to keep the effective resonant frequency of the source within a desired range of frequencies.

If greater control over the resonant frequency is required, an adjustable compliant compartment system can be used. For example, according to an embodiment illustrated in FIG. 26, a gas volume 2603 is contained within moveable partition 2601. Moveable partition is shown at a first position. Moveable partition can extend to occupy a second position 2605 having a different gas volume. Gas cylinder/reservoir 2617 is filled with a supply of high-pressure gas, for example, filled to 300 bars pressure. The outlet of cylinder 2617 connects to a metering device 2609, for example, a gas valve whose outlet is in communication with gas volume 2603. Metering device 2609 may also contain internal devices like electronics or pressure regulating devices for control. Metering device 2609 may have sensing means (e.g., a pressure sensor) to measure the local operating environment parameters, for example, ambient pressure, or temperature or other inputs shown as 2611.

In addition, metering device 2609 may be in communication with other external devices, for example, other control/management equipment 2619 that may be located also in the borehole or at the surface. Umbilical 2613 interconnects control equipment 2619, metering device 2609 and other sensors 2607 and may provide power, and/or a communication link. Sensor 2607 may be, for example, a device suitable for measuring/estimating volume 2603. Control equipment 2609 may contain means to vent the gas into the borehole. In this embodiment, at modest depths, gas volume 2603 is nominally at the hydrostatic pressure corresponding to the operating depth. Gas volume 2603 can be increased or reduced through the action of metering device 2609, which can supply or vent gas, upon receiving a command signal, either generated internally based upon some internal program or from control equipment 2619.

Thus, for example, in one operational embodiment, at a modest depth, gas volume 2603 is small. When the source is at a larger depth, gas is introduced by metering device 2609 to increase the gas volume 2603 and barrier 2601 moves to a new position 2605, thus increasing the gas volume is a way to offset the increase in pressure to maintain a more constant compliance value. Other means are possible. In a different embodiment, gas volume 2603 can be adjusted, optionally, in combination with positioning of at least one packer, to tune the source to excite a particular resonance mode in the borehole. The excitation resonance mode may be axial and/or radial in direction and may be a fundamental or higher order resonance mode.

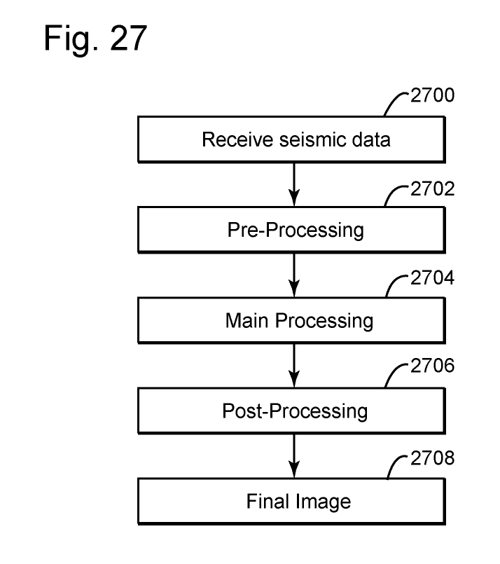

Seismic data generated by the seismic sources discussed above and acquired with the streamers also noted above may be processed in a corresponding processing device for generating a final image of the surveyed subsurface as discussed now with regard to FIG. 27. For example, the seismic data generated with the source elements as discussed with regard to FIGS. 4A to 26 may be received in step 2700 at the processing device. In step 2702, pre-processing methods are applied, e.g., demultiple, signature deconvolution, trace summing, motion correction, vibroseis correlation, resampling, etc. In step 2704, the main processing takes place, e.g., deconvolution, amplitude analysis, statics determination, common middle point gathering, velocity analysis, normal move-out correction, muting, trace equalization, stacking, noise rejection, amplitude equalization, etc. In step 2706, final or post-processing methods are applied, e.g., migration, wavelet processing, seismic attribute estimation, inversion, etc.; in step 2708 the final image of the subsurface is generated.

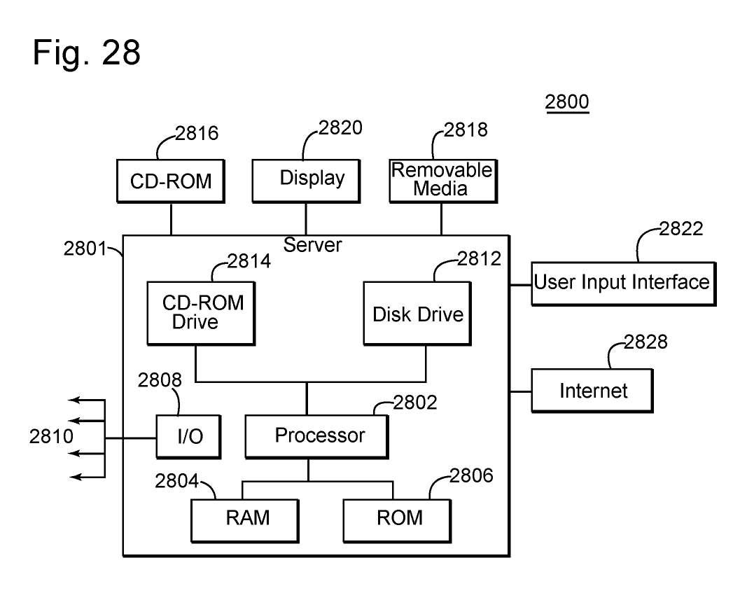

An example of a representative processing device capable of carrying out operations in accordance with the embodiments discussed above is illustrated in FIG. 28. Such a processing device may be any of the controllers discussed in the previous embodiments. Hardware, firmware, software or a combination thereof may be used to perform the various steps and operations described herein.

The exemplary processing device 2800 suitable for performing the activities described in the exemplary embodiments may include server 2801. Such a server 2801 may include a central processor unit (CPU) 2802 coupled to a random access memory (RAM) 2804 and/or to a read-only memory (ROM) 2806. The ROM 2806 may also be other types of storage media to store programs, such as programmable ROM (PROM), erasable PROM (EPROM), etc. Processor 2802 may communicate with other internal and external components through input/output (I/O) circuitry 2808 and bussing 2810 to provide control signals and the like. For example, processor 2802 may communicate with the various elements of each source element. Processor 2802 carries out a variety of functions as are known in the art, as dictated by software and/or firmware instructions.

Server 2801 may also include one or more data storage devices, including disk drives 2812, CD-ROM drives 2814, and other hardware capable of reading and/or storing information, such as a DVD, etc. In one embodiment, software for carrying out the above-discussed steps may be stored and distributed on a CD-ROM 2816, removable media 2818 or other form of media capable of storing information. The storage media may be inserted into, and read by, devices such as the CD-ROM drive 2814, disk drive 2812, etc. Server 2801 may be coupled to a display 2820, which may be any type of known display or presentation screen, such as LCD, plasma displays, cathode ray tubes (CRT), etc. A user input interface 2822 is provided, including one or more user interface mechanisms such as a mouse, keyboard, microphone, touch pad, touch screen, voice-recognition system, etc.

Server 2801 may be coupled to other computing devices, such as the equipment of a vessel, via a network. The server may be part of a larger network configuration as in a global area network (GAN) such as the Internet 2828, which allows ultimate connection to various landline and/or mobile client/watcher devices.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized, including hard disks, CD-ROMs, digital versatile discs (DVD), optical storage devices or magnetic storage devices such a floppy disk or magnetic tape. Other non-limiting examples of computer-readable media include flash-type memories or other known types of memories.

This written description uses examples of the subject matter disclosed to enable any person skilled in the art to practice the same, including making and using any devices or systems and performing any incorporated methods. For greater clarity, the figures used to help describe the invention are simplified to illustrate key features. For example, figures are not to scale and certain elements may be disproportionate in size and/or location. Furthermore, it is anticipated that the shape of various components may be different when reduced to practice, for example, to improve their hydrodynamic properties, to reduce towing force or for other reasons. Also, elements like flow diverters and/or vanes and/or wings that may be located on the source element housing structure to improve efficiency, operability, handling, utility or to promote certain preferred directions of fluid flow are not shown. These and other means can be incorporated into any embodiment to further improve the overall performance and/or function of the invention. The patentable scope of the subject matter is defined by the claims, and may include other examples that occur to those skilled in the art. Such other examples are intended to be within the scope of the claims. Those skilled in the art would appreciate that features from any embodiments may be combined to generate a new embodiment.

The disclosed embodiments provide a method and source element capable of boosting an energy generated in the 0.1 to 10 Hz range. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A low-frequency source element for generating seismic waves in water, the low-frequency source element comprising:
a hydraulic reservoir configured to hold a given fluid volume;
a compliant chamber configured to hold a given gas volume and to accommodate volume changes of the given fluid volume;
a rotational kinetic energy actuator configured to impart rotational kinetic energy to the fluid volume; and
a flow modulator device configured to transform part of the rotational kinetic energy of the fluid volume into translational energy to generate an acoustic signal.

2. The source element of claim 1, wherein the acoustic signal has a frequency below 5 Hz.

3. The source element of claim 1, wherein the fluid volume is seawater and the gas volume is air, nitrogen, or a noble gas.

4. The source element of claim 1, further comprising:
a moveable barrier that separates the hydraulic reservoir from the compliant chamber.

5. The source element of claim 4, wherein the moveable barrier is a piston.

6. The source element of claim 4, wherein the moveable barrier is a flexible membrane.

7. The source element of claim 1, wherein the rotational kinetic energy actuator includes:
a motor; and
a paddle configured to be rotated by the motor and generate the rotational kinetic energy.

8. The source element of claim 1, wherein the flow modulator device comprises:
a vane located in the hydraulic reservoir; and
a torque producing device connected to the vane and configured to rotate vane so that part of the given fluid volume moves along a longitudinal axis (A) of the source element or along a radial axis.

9. The source element of claim 1, wherein the given fluid volume is insulated from an ambient of the source element.

10. A method for generating low-frequency seismic signals, the method comprising:
deploying a source element in water;
towing the source element with a vessel; and
generating low-frequency seismic signals by transforming, with a flow modulator device, part of a rotational kinetic energy of a fluid volume hold by a hydraulic reservoir into translational energy.

11. The method of claim 10, further comprising:
imparting rotational kinetic energy to the fluid volume with a rotational kinetic energy actuator.

12. The method of claim 10, further comprising:
compressing and decompressing a given gas volume housed by a compliant chamber when the part of the rotational kinetic energy of the fluid volume is transformed into translational energy.

13. The method of claim 10, further comprising:
towing at least one streamer; and
recording seismic waves generated by the source element with a receiver located along the at least one streamer.

14. A low-frequency source element for generating seismic waves in water, the low-frequency source element comprising:
a working chamber;
a compliant chamber in a same housing as the working chamber;
a rotational kinetic energy actuator configured to impart rotational kinetic energy to a fluid volume inside the working chamber; and
a flow modulator device configured to transform part of the rotational kinetic energy of the fluid volume into translational energy to generate an acoustic signal,
wherein the housing houses the working chamber, the compliant chamber, the rotational kinetic energy actuator and the flow modulator.

15. The source of claim 14, wherein the housing has one end open.

16. The source of claim 14, wherein both ends of the housing are closed.

17. The source of claim 14, wherein the housing acts as a monopole.

18. The source of claim 14, wherein there is a zero net movement of the fluid volume outside the housing.

19. The source of claim 14, wherein the rotational kinetic energy actuator includes:
a motor; and
a paddle configured to be rotated by the motor and generate the rotational kinetic energy.

20. The source of claim 19, wherein the flow modulator device comprises:
a vane located in the working chamber; and
a torque producing device connected to the vane and configured to rotate vane so that part of the given fluid volume moves along a longitudinal axis (A) of the source element or along a radial axis.
